(19) United States
(12) Patent Application Publication
(10) Pub. No.: US 2024/0407464 A1
(43) Pub. Date: Dec. 12, 2024

(54) AEROSOL PROVISION DEVICE

(71) Applicant: NICOVENTURES TRADING LIMITED, London (GB)

(72) Inventors: Lois MOLLISON-BALL, London (GB); Jonathan Neil BURGESS, London (GB); Michael THOMAS, London (GB); Will ENGLAND, London (GB)

(21) Appl. No.: 18/701,782

(22) PCT Filed: Oct. 18, 2022
(86) PCT No.: PCT/EP2022/078981

§ 371 Date: Apr. 16, 2024

(30) Foreign Application Priority Data
Oct. 26, 2021 (GB) 2115369.7

(51) Int. Cl. A24F 40/57; A24F 40/20; A24F 40/46; A24F 40/465; A24F 40/53; A24F 40/60; H05B 1/02

(52) U.S. Cl. CPC A24F 40/57; A24F 40/20; A24F 40/46; A24F 40/465; A24F 40/53; A24F 40/60; H05B 1/0252

(57) ABSTRACT

An aerosol provision device, for generating aerosol from aerosol generating material, can include one or more aerosol generators arranged to cause aerosol to be generated from the aerosol generating material, a controller for controlling the aerosol generators, and a user interface. The user interface may be arranged so as to enable a user to interact with the user interface at a time after a session of use has commenced in order to cause the controller either: (i) to pause or alter further operation of the aerosol generators; and/or (ii) to cause the aerosol generators to enter into a power saving mode of operation; and/or (iii) to change or vary a heating profile which is set for the aerosol generators for the remainder of the session; and/or (iv) to change or vary the duration of a heating profile which is set for the aerosol generators for the remainder of the session.

### RELATED APPLICATIONS

The present application is a National Phase entry of PCT Application No. PCT/EP2022/078981 filed Oct. 18, 2022, which claims priority to GB Application No. 2115369.7 filed Oct. 26, 2021, each of which is hereby incorporated by reference in their entirety.

### TECHNICAL FIELD

The present disclosure relates to an aerosol provision device, an aerosol generating system and a method of generating an aerosol.

### BACKGROUND

Articles such as cigarettes, cigars and the like burn tobacco during use to create tobacco smoke. Attempts have been made to provide alternatives to these types of articles, which burn tobacco, by creating products that release compounds without burning. Apparatus is known that heats smokable material to volatilize at least one component of the smokable material, typically to form an aerosol which can be inhaled, without burning or combusting the smokable material. Such apparatus is sometimes described as a “heat-not-burn” apparatus or a “tobacco heating product” (THP) or “tobacco heating device” or similar. Various different arrangements for volatilizing at least one component of the smokable material are known.

The material may be for example tobacco or other non-tobacco products or a combination, such as a blended mix, which may or may not contain nicotine.

It is desired to provide an improved aerosol provision device.

### SUMMARY

According to an aspect there is provided an aerosol provision device for generating aerosol from aerosol generating material, wherein the aerosol provision device comprises:
one or more aerosol generators arranged to cause aerosol to be generated from the aerosol generating material;
a controller for controlling the one or more aerosol generators; and
a user interface arranged so as to enable a user to interact with the user interface at a time t1 after a session of use has commenced in order to cause the controller either: (i) to pause or alter further operation of the one or more aerosol generators; and/or (ii) to cause the one or more aerosol generators to enter into a power saving mode of operation; and/or (iii) to change or vary a heating profile which is set for the one or more aerosol generators for the remainder of the session of use from time t1 onwards; and/or (iv) to change or vary the duration of a heating profile which is set for the one or more aerosol generators for the remainder of the session of use from time t1 onwards.

Various embodiments relate to an aerosol provision device wherein a user can interact with a user interface after a session of use has commenced in order to interrupt or alter the heating profile which is set for the one or more aerosol generators for the remainder of a session of use.

According to an embodiment if the controller is caused to pause or alter further operation of the one or more aerosol generators then the controller may be further arranged to reduce energy or power supplied to the one or more aerosol generators so that the operational temperature of the one or more aerosol generators drops to a temperature T1, wherein T1≤200° C. Optionally, T1 is selected from the group consisting of: (i)<20° C.; (ii) 20-40° C.; (iii) 40-60° C.; (iv) 60-80° C.; (v) 80-100° C.; (vi) 100-120° C.; (vii) 120-140° C.; (viii) 140-160° C.; (ix) 160-180° C.; and (x) 180-200° C.

If the controller is caused to pause or alter further operation of the one or more aerosol generators then the controller may be further arranged to turn OFF energy or power supplied to the one or more aerosol generators.

If the controller is caused to pause or alter further operation of the one or more aerosol generators then the controller may be further arranged to prevent aerosol from being generated from the aerosol generating material.

The user interface may be further arranged so as to enable a user to further interact with the user interface at a subsequent time t2 in order to cause the controller either: (i) to restart operation of the one or more aerosol generators; and/or (ii) to cause the one or more aerosol generators to exit from a power saving mode of operation.

The controller may be further arranged to turn OFF energy or power supplied to the one or more aerosol generators after a predetermined period of time subsequent to time t1 if a user has not further interacted with the user interface subsequent to time t1. The predetermined period of time may be <10 s, 10-20 s, 20-30 s, 30-40 s, 40-50 s, 50-60 s, 60-70 s, 70-80 s, 80-90 s, 90-100 s, 100-110 s, 110-120 s, 120-130 s, 130-140 s, 140-150 s, 150-160 s, 160-170 s, 170-180 s or >180 s.

According to an embodiment prior to time t1 the controller is arranged to set a first heating profile for the one or more aerosol generators having a first average operating temperature T1 throughout an intended session of use and wherein following interaction by a user with the user interface from time t1 onwards the controller is arranged to set a second different heating profile for the one or more aerosol generators so that the one or more aerosol generators have a second average operating temperature T2 throughout the session of use, wherein either T1>T2 or T2>T1.

According to an embodiment following interaction by a user with the user interface at time t1 the controller is arranged to increase or progressively increase the operational temperature of the one or more aerosol generators.

According to an embodiment following interaction by a user with the user interface at time t1 the controller is arranged to decrease or progressively decrease the operational temperature of the one or more aerosol generators.

Following interaction by a user with the user interface at time t1 the controller may be arranged to increase the duration of a heating profile which is set for the one or more aerosol generators for the remainder of the session of use from time t1 onwards.

Following interaction by a user with the user interface at time t1 the controller may be arranged to decrease the duration of a heating profile which is set for the one or more aerosol generators for the remainder of the session of use from time t1 onwards.

Following interaction by a user with the user interface at time t1 the controller may be arranged to set a different predetermined heating profile for the one or more aerosol generators.

The one or more aerosol generators may comprise one or more induction heating units.

The one or more aerosol generators may comprise one or more resistive or non-induction heating units.

The one or more aerosol generators may comprise one or more external heating units.

The one or more aerosol generators comprise one or more internal heating units.

If the controller is caused to change or vary a heating profile which is set for the one or more aerosol generators for the remainder of the session of use from time t1 onwards then the controller may be further arranged to increase or decrease the temperature of the one or more aerosol generators.

The one or more aerosol generators may comprise a first heating unit and a second heating unit.

According to an embodiment either: (i) the first heating unit comprises an induction heating unit and the second heating unit comprises an induction heating unit; (ii) the first heating unit comprises an induction heating unit and the second heating unit comprises a resistive or non-induction heating unit; (iii) the first heating unit comprises a resistive or non-induction heating unit and the second heating unit comprises an induction heating unit; or (iv) the first heating unit comprises a resistive or non-induction heating unit and the second heating unit comprises a resistive or non-induction heating unit.

According to an embodiment either: (i) the first heating unit comprises an external heating unit and the second heating unit comprises an external heating unit; (ii) the first heating unit comprises an external heating unit and the second heating unit comprises an internal heating unit; (iii) the first heating unit comprises an internal heating unit and the second heating unit comprises an internal heating unit; or (iv) the first heating unit comprises an internal heating unit and the second heating unit comprises an external heating unit.

If the controller is caused to change or vary a heating profile which is set for the one or more aerosol generators for the remainder of the session of use from time t1 onwards then the controller may be arranged to increase or reduce the temperature of the first heating unit.

If the controller is caused to change or vary a heating profile which is set for the one or more aerosol generators for the remainder of the session of use from time t1 onwards then the controller may be arranged to increase or reduce the temperature of the second heating unit.

A session of use may be determined to begin when power or energy is first supplied to the one or more aerosol generators after an aerosol generating article has been inserted into the aerosol provision device.

A session of use may be determined to begin when power or energy is first supplied to the one or more aerosol generators in order to raise the temperature of the one or more aerosol generators to an operating temperature Tmin such that a user can take a first puff of aerosol generated from the aerosol generating material. Optionally, Tmin is in the range: (i) 200-210° C.; (ii) 210-220° C.; (iii) 220-230° C.; (iv) 230-240° C.; (v) 240-250° C.; (vi) 250-260° C.; (vii) 260-270° C.; (viii) 270-280° C.; (ix) 280-290° C.; and (x) 290-300° C.

A session of use may be determined to end when power or energy is no longer supplied to the one or more aerosol generators.

A session of use may be determined to end when the aerosol generating material is substantially spent or wherein a user is unable to take further puffs of aerosol generated from the aerosol generating material.

A session of use may be determined to relate to a period of time during which a user is enabled to take multiple puffs of aerosol generated from aerosol generating material without replacement or replenishment of the aerosol generating material.

The aerosol provision device may further comprise a first device arranged to detect the frequency at which a user is taking puffs of aerosol, wherein if the frequency is above or below a pre-determined level then the controller is further arranged to prompt a user to interact with the user interface.

The first device may comprise a microphone.

The aerosol provision device may further comprise a second device arranged to detect the frequency at which a user is taking puffs of aerosol, wherein if the frequency is below a pre-determined level then the controller is further arranged either to pause the operation of the one or more aerosol generators or to turn OFF energy or power supplied to the one or more aerosol generators.

According to another aspect there is provided an aerosol generating system comprising:
an aerosol provision device as described above; and
an aerosol generating article comprising aerosol generating material.

The aerosol generating article is inserted, in use, into the aerosol provision device.

According to another aspect there is provided a method of generating aerosol comprising:
providing an aerosol provision device comprising one or more aerosol generators arranged to cause aerosol to be generated from the aerosol generating material and wherein the aerosol provision device further comprises a user interface;
inserting an aerosol generating article into the aerosol provision device; and
in response to a user interacting with the user interface at a time t1 after a session of use has commenced, either: (i) pausing or altering further operation of the one or more aerosol generators; and/or (ii) causing the one or more aerosol generators to enter into a power saving mode of operation; and/or (iii) changing or varying a heating profile which is set for the one or more aerosol generators for the remainder of the session of use from time t1 onwards; and/or (iv) changing or varying the duration of a heating profile which is set for the one or more aerosol generators for the remainder of the session of use from time t1 onwards.

### BRIEF DESCRIPTION OF THE DRAWINGS

Various embodiments will now be described, by way of example only, and with reference to the accompanying drawings in which:

FIG. 1A is a schematic diagram of a heating assembly of an aerosol provision device and FIG. 1B is a cross-section of the heating assembly shown in FIG. 1A with an aerosol generating article disposed therein;

FIG. 2A is a schematic cross-section of an aerosol generating article for use with the aerosol provision device and FIG. 2B is a perspective view of the aerosol provision article;

FIG. 3 is a graph showing a general temperature profile of a first heating unit in an aerosol provision device during an exemplary smoking session;

FIG. 4 is a graph showing a general temperature profile of a second heating unit in an aerosol provision device during an exemplary smoking session;

FIG. 5 is a graph showing a general programmed heating profile of a heating element in an aerosol provision device during an exemplary session of use;

FIG. 6 shows an aerosol provision device according to an embodiment having a user interface wherein a user may press the user interface after a session of use has commenced in order to pause the operation of the aerosol provision device or select a different heating profile;

FIG. 7 shows a heating profile which may be set for one or more aerosol generators of an aerosol provision device according to an embodiment;

FIG. 8 shows a heating profile which may be set for one or more aerosol generators of an aerosol provision device according to an embodiment wherein a user has interacted with a user interface during a session of use at time t1 in order to pause the operation of the aerosol generators and wherein at a subsequent time t2 the user has interacted with the user interface a second time in order to resume operation of the aerosol generators;

FIG. 9 shows a heating profile which may be set for one or more aerosol generators of an aerosol provision device according to an embodiment wherein a user has interacted with a user interface a first time t1 during a session of use in order to cause the aerosol provision device to enter a power saving mode of operation in which power is turned OFF to the aerosol generators and wherein the user has interacted with the user interface a second time at a second time t2 in order to cause the aerosol provision device to exit from the power saving mode of operation and resume operation;

FIG. 10 shows a heating profile which may be set for one or more aerosol generators of an aerosol provision device according to an embodiment wherein a user has interacted with a user interface during a session of use at a time t1 in order to change the heating profile which is set for the one or more aerosol generators for the remainder of the session of use; and

FIG. 11 shows a heating profile which may be set for one or more heating units of an aerosol provision device according to an embodiment wherein a user has interacted with a user interface during a session of use in order to extend the duration of the heating profile.

### DETAILED DESCRIPTION

The term “aerosol generating material” includes materials that provide volatilized components upon heating, typically in the form of an aerosol. Aerosol generating material includes any tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”. In an embodiment, the aerosol generating material is a non-liquid aerosol generating material. In a particular embodiment, the non-liquid aerosol generating material comprises tobacco.

Apparatus is known that heats aerosol generating material to volatilize at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product”, a “tobacco heating product device”, a “tobacco heating device” or similar. In an embodiment the aerosol provision device is a tobacco heating product. The non-liquid aerosol generating material for use with a tobacco heating product comprises tobacco.

E-cigarette devices are also known which comprise aerosol provision devices which vaporize an aerosol generating material in the form of a liquid, which may or may not contain nicotine. The aerosol generating material may be in the form of or be provided as part of a rod, cartridge or cassette or the like which can be inserted into the apparatus. A heater for heating and volatilizing the aerosol generating material may be provided as a “permanent” part of the apparatus.

Aerosol provision devices are also known which generate aerosol from a hybrid aerosol generating article. The hybrid aerosol generating article comprises a section which includes a cartomizer which includes a liquid or gel aerosol generating material and another section which includes solid aerosol generating material such as tobacco granules.

An aerosol provision device can receive an article comprising aerosol generating material for heating, also referred to as a “smoking article”. An “article”, “aerosol generating article” or “smoking article” in this context is a component that includes or contains in use the aerosol generating material, which is heated to volatilize the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

The aerosol provision device according to various embodiments comprises a plurality of aerosol generators for generating aerosol from aerosol generating material in use.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

A heating unit typically refers to a component which is arranged to receive electrical energy from an electrical energy source, and to supply thermal energy to an aerosol generating material. A heating unit may comprise a heating element. A heating element is typically a material which is arranged to supply heat to an aerosol generating material in use. The heating unit comprising the heating element may comprise any other component required, such as a component for transducing the electrical energy received by the heating unit. In other examples, the heating element itself may be configured to transduce electrical energy to thermal energy.

The heating unit may comprise an induction coil. In some examples, the coil is configured to cause heating of at least one electrically-conductive heating element, so that heat energy is conductible from the at least one electrically-conductive heating element to aerosol generating material to thereby cause heating of the aerosol generating material.

In some examples, the coil may be configured to generate, in use, a varying magnetic field for penetrating at least one heating element, to thereby cause induction heating and/or magnetic hysteresis heating of the at least one heating element. In such an arrangement, the or each heating element may be termed a “susceptor”. A coil that is configured to generate, in use, a varying magnetic field for penetrating at least one electrically-conductive heating element, to thereby cause induction heating of the at least one electrically-conductive heating element, may be termed an “induction coil” or “inductor coil”.

In some examples, the coils may be helical. In some examples, the coils may encircle at least a part of a heating zone of the aerosol provision device that is configured to receive aerosol generating material. In some examples, the coils are a helical coils that encircle at least a part of the heating zone.

It has been found that induction heating units in an aerosol provision device reach a maximum operating temperature much more rapidly than corresponding resistive heating elements. According to various embodiments, the aerosol provision device may be configured such that one or both heating units reaches its maximum operating temperature at a rate of at least 100° C. per second. In a particular embodiment, the aerosol provision device may be configured such that one or both heating units reaches the maximum operating temperature at a rate of at least 150° C. per second.

Induction heating systems may be of interest because the varying magnetic field magnitude can be easily controlled by controlling power supplied to the heating unit. Moreover, as induction heating does not require a physical connection to be provided between the source of the varying magnetic field and the heat source, design freedom and control over the heating profile may be greater, and cost may be lower.

The aerosol provision device may comprise a heating assembly. The heating assembly may comprise a first heating unit and a second heating unit.

The first heating unit and the second heating unit may comprise induction heating units and the units may be controllable independent from each other. Heating the aerosol generating material with independent heating units may provide more accurate control of heating of the aerosol generating material. Independently controllable heating units may also provide thermal energy differently to each portion of the aerosol generating material, resulting in differing temperature profiles across portions of the aerosol generating material.

According to various embodiments, the first and second heating units may be configured to have temperature profiles which differ from each other in use. This may provide asymmetrical heating of the aerosol generating material along a longitudinal plane between the mouth end and the distal end of the aerosol provision device when the aerosol provision device is in use.

Alternatively, the first and second heating units may be configured to have temperature profiles which are substantially the same in use. This may provide symmetrical heating of the aerosol generating material along a longitudinal plane between the mouth end and the distal end of the aerosol provision device when the aerosol provision device is in use.

An object that is capable of being inductively heated is known as a susceptor. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

Reference may be made to the temperature of one or more heating units or heating elements throughout the present specification. The temperature of a heating unit or heating element may also be conveniently referred to as the temperature of the heating unit which comprises the heating element. This does not necessarily mean that the entire heating unit is at the given temperature. For example, where reference is made to the temperature of an induction heating unit, it does not necessarily mean that both the inductive element and the susceptor have such a temperature. Rather, in this example, the temperature of the induction heating unit corresponds to the temperature of the heating element composed in the induction heating unit. For the avoidance of doubt, the temperature of a heating element and the temperature of a heating unit can be used interchangeably.

As used herein, “temperature profile” or “heating profile” refers to the variation of temperature of a material over time. For example, the varying temperature of a heating element or heating unit measured at the heating element or heating unit for the duration of a smoking session may be referred to as the temperature profile or heating profile of that heating element or heating unit. The heating elements or heating units provide heat to the aerosol generating material during use, to generate an aerosol. The temperature profile or heating profile of the heating element or heating unit therefore induces the temperature profile of aerosol generating material disposed near the heating element or heating unit.

“Operating temperature” as used herein in relation to a heating element or heating unit refers to any heating element temperature at which the element can heat an aerosol generating material to produce sufficient aerosol for a satisfactory puff without burning the aerosol generating material. The maximum operating temperature of a heating element or heating unit is the highest temperature reached by the heating element or heating unit during a smoking session. The lowest operating temperature of the heating element or heating unit refers to the lowest heating element temperature at which sufficient aerosol can be generated from the aerosol generating material by the heating element or heating unit for a satisfactory puff. Where there are a plurality of heating elements or heating units present in the aerosol provision device, each heating element or heating unit has an associated maximum operating temperature. The maximum operating temperature of each heating element or heating unit may be the same, or it may differ for each heating element or heating unit.

In the aerosol provision device according to an embodiment each heating element or heating unit may be arranged to heat, but not burn, aerosol generating material. Although the temperature profile or heating profile of each heating element or heating unit may induce the temperature profile of each associated portion of aerosol generating material, the temperature profiles or heating profiles of the heating element or heating unit and the associated portion of aerosol generating material may not exactly correspond. For example, there may be “bleed” in the form of conduction, convection and/or radiation of heat energy from one portion of the aerosol generating material to another; there may be variations in conduction, convection and/or radiation of heat energy from the heating elements or heating units to the aerosol generating material; there may be a lag between the change in the temperature profile of the heating element or heating unit and the change in the temperature profile of the aerosol generating material, depending on the heat capacity of the aerosol generating material.

The aerosol provision device may comprise a controller for controlling each heating unit present in the aerosol provision device. The controller may comprise a printed circuit board (“PCB”). The controller may be configured to control the power supplied to each heating unit, and control the “programmed heating profile” of each heating unit present in the aerosol provision device. For example, the controller may be programmed to control the current supplied to a plurality of inductors to control the resulting temperature profiles or heating profiles of the corresponding induction heating elements or induction heating units. As between the temperature profile of heating elements/units and aerosol generating material described above, the programmed heating profile of a heating element or heating unit may not exactly correspond to the observed temperature profile of a heating element or heating unit, for the same reasons given above.

The term “operating temperature” can also be used in relation to the aerosol generating material. In this case, the term refers to any temperature of the aerosol generating material itself at which sufficient aerosol is generated from the aerosol generating material for a satisfactory puff. The maximum operating temperature of the aerosol generating material is the highest temperature reached by any part of the aerosol generating material during a smoking session. In some embodiments, the maximum operating temperature of the aerosol generating material is greater than 200° C., 210° C., 220° C., 230° C., 240° C., 250° C., 260° C. or 270° C. In some embodiments, the maximum operating temperature of the aerosol generating material is less than 300° C., 290° C., 280° C., 270° C., 260° C. or 250° C. The lowest operating temperature is the lowest temperature of aerosol generating material at which sufficient aerosol is generated from the material to product sufficient aerosol for a satisfactory “puff”. In some embodiments, the lowest operating temperature of the aerosol generating material is greater than 90° C., 100° C., 110° C., 120° C., 130° C., 140° C. or 150° C. In some embodiments, the lowest operating temperature of the aerosol generating material is less than 150° C., 140° C., 130° C. or 120° C.

Various embodiments are disclosed which reduce the amount of time it takes for an aerosol provision device to be ready for use, and more generally improve the inhalation experience for a user. Surprisingly, it has been found that reducing the time taken for a heating element or heating unit to reach an operating temperature may at least partially alleviate “hot puff”, a phenomenon which occurs when the generated aerosol contains a high water content. Accordingly, the aerosol provision device according to various embodiments may provide an inhalable aerosol to a consumer which has better organoleptic properties than an aerosol provided by a conventional aerosol provision device which does not include a heating unit which reaches a maximum operating temperature as rapidly.

In some embodiments, the aerosol provision device is configured such that at least one heating element or heating unit in the device reaches its maximum operating temperature within 20 seconds, and the first temperature at which the at least one heating unit is held for at least 1 second, 2 seconds, 3 seconds, 4 seconds, 5 seconds, 10 seconds, or 20 seconds is the maximum operating temperature. That is, in these embodiments, the heating unit is not held at a temperature which is not the maximum operating temperature before reaching the maximum operating temperature.

In some embodiments, the at least one heating unit reaches its maximum operating temperature within the given period from ambient temperature.

The aerosol provision device may be configured to operate as described herein. The aerosol provision device may at least partially be configured to operate in this manner by a controller which may be programmed to operate the device in one or more different modes. Accordingly, references herein to the configuration of the aerosol provision device or components thereof may refer to the controller being programmed to operate the aerosol provision device as disclosed herein, amongst other features (such as spatial arrangement of the heating units).

Aerosol generating articles for aerosol provision devices (such as tobacco heating products) usually contain more water and/or aerosol generating agent than combustible smoking articles to facilitate formation of an aerosol in use. This higher water and/or aerosol generating agent content can increase the risk of condensate collecting within the aerosol provision device during use, particularly in locations away from the heating unit(s). This problem may be greater in aerosol provision devices with enclosed heating chambers, and particularly those with external heaters, than those provided with internal heaters (such as “blade” heaters). Without wishing to be bound by theory, it is believed that since a greater proportion/surface area of the aerosol generating material is heated by external-heating heating assemblies, more aerosol is released than an aerosol provision device which heats the aerosol generating material internally, leading to more condensation of the aerosol within the aerosol provision device.

Various programmed heating profiles may be employed in an aerosol provision device configured to externally and/or internally heat aerosol generating material to provide a desirable amount of aerosol to the user whilst keeping the amount of aerosol which condenses inside the aerosol provision device relatively low. For example, the maximum operating temperature of a heating unit may affect the amount of condensate formed. It may be that lower maximum operating temperatures provide less undesirable condensate. The difference between maximum operating temperatures of heating units in a heating assembly may also affect the amount of condensate formed. Further, the point in a session of use at which each heating unit reaches its maximum operating temperature may affect the amount of condensate formed.

In use, the aerosol provision device may heat an aerosol generating material to provide an inhalable aerosol. The aerosol provision device may be referred to as “ready for use” when at least a portion of the aerosol generating material has reached a lowest operating temperature and a user can take a puff which contains a satisfactory amount of aerosol. In some embodiments the aerosol provision device may be ready for use within approximately 20 seconds of supplying power to one or both heating units, or 15 seconds, or 10 seconds or 5 seconds. The aerosol provision device may be ready for use within approximately 20 seconds of activation of the device, or 15 seconds, or 10 seconds or 5 seconds. The aerosol provision device may begin supplying power to a heating unit such as the first heating unit or the second heating unit when the device is activated, or it may begin supplying power to the heating unit after the aerosol provision device is activated. The aerosol provision device may be configured such that power starts being supplied to one or the heating units some time after activation of the aerosol provision device, such as at least 1 second, 2 seconds or 3 seconds after activation of the aerosol provision device. The aerosol provision device may be configured such that power is not supplied to one of the heating units, or any heating unit present in the heating assembly until at least 2.5 seconds after activation of the aerosol provision device. This may prolong battery life by avoiding unintentional activation of the heating unit(s).

The aerosol provision device may be ready for use more quickly than corresponding aerosol provision devices known in the art, providing an improved user experience. Generally, the point at which the aerosol provision device is ready for use will be some time after one of the heating units has reached its maximum operating temperature, as it will take some amount of time to transfer sufficient thermal energy from the heating unit to the aerosol generating material in order to generate the aerosol. The aerosol provision device may be ready for use within 20 seconds of one of the heating units reaching its maximum operating temperature, or 15 seconds, or 10 seconds or 5 seconds.

In some embodiments, the user's sensorial experience arising from the aerosol generated by the present device is like that of smoking a combustible cigarette, such as a factory-made cigarette.

The aerosol provision device may indicate that it is ready for use via an indicator. In an embodiment, the aerosol provision device may be configured such that the indicator indicates that the aerosol provision device is ready for use within approximately 20 seconds of power being supplied to one of the heating units, or 15 seconds, or 10 seconds or 5 seconds. In a particular embodiment, the aerosol provision device may be configured such that the indicator indicates that the aerosol provision device is ready for use within approximately 20 seconds of activation of the device, or 15 seconds, or 10 seconds or 5 second. In another embodiment, the device is configured such that the indicator indicates that the device is ready for use within approximately 20 seconds of the first heating unit reaching its maximum operating temperature, or 15 seconds, or 10 seconds.

As used herein, “puff” refers to a single inhalation by the user of the aerosol generated by the aerosol provision device.

“Session of use” as used herein refers to a single period of use of the aerosol provision device by a user. The session of use begins at the point at which power is first supplied to at least one aerosol generator present in the heating assembly. The device will be ready for use after a period of time has elapsed from the start of the session of use.

The session of use may end at the point at which no power is supplied to any of the aerosol generators in the aerosol provision device. The end of the session of use may coincide with the point at which the aerosol generating article is depleted (the point at which the total particulate matter yield (mg) in each puff would be deemed unacceptably low by a user). The session may comprise a plurality of puffs. The session may have a duration less than 7 minutes, or 6 minutes, or 5 minutes, or 4 minutes and 30 seconds, or 4 minutes, or 3 minutes and 30 seconds. In some embodiments, the session of use may have a duration of from 2 to 5 minutes, or from 3 to 4.5 minutes, or 3.5 to 4.5 minutes or approximately 4 minutes. A session may be initiated by the user actuating a button or switch on the device, causing at least one heating unit to begin rising in temperature when activated or some time after activation.

A session of use may be determined to begin when power or energy is first supplied to an aerosol generator after an aerosol generating article has been inserted into the aerosol provision device. A session of use may be determined to begin when power or energy is first supplied to one or more aerosol generators in order to raise the temperature of the one or more aerosol generators to an operating temperature Tmin such that a user can take a first puff of aerosol generated from the aerosol generating material. According to various embodiments Tmin may be in the range: (i) 200-210° C.; (ii) 210-220° C.; (iii) 220-230° C.; (iv) 230-240° C.; (v) 240-250° C.; (vi) 250-260° C.; (vii) 260-270° C.; (viii) 270-280° C.; (ix) 280-290° C.; and (x) 290-300° C.

A session of use may be determined to end when power or energy is no longer supplied to the one or more aerosol generators. A session of use may be determined to end when the aerosol generating material is substantially spent or wherein a user is unable to take further puffs of aerosol generated from the aerosol generating material.

A session of use may be determined to relate to a period of time during which a user is enabled to take multiple puffs of aerosol generated from aerosol generating material without replacement or replenishment of the aerosol generating material.

In some embodiments, the aerosol provision device may be operable in at least a first (e.g. base) mode of operation and a second (e.g. boost) mode of operation.

The heating assembly may be operable in a maximum of two modes of operation, or may be operable in more than two modes, such as three modes, four modes, or five modes.

Each mode of operation may be associated with a predetermined heating profile for each heating unit in the heating assembly, such as a programmed heating profile. One or more of the programmed heating profiles may be programmed or selected by a user. Additionally, or alternatively, one or more of the programmed heating profiles may be programmed by the manufacturer. In these examples, the one or more programmed heating profiles may be fixed such that an end user cannot alter the one or more programmed heating profiles.

The modes of operation may be selectable by a user. For example, the user may select a desired mode of operation by interacting with a user interface. Power may begin to be supplied to a first heating unit at substantially the same time as the desired mode of operation is selected.

Each mode may be associated with a temperature profile which differs from the temperature profiles of the other modes. Further, one or more modes may be associated with a different point at which the device is ready for use. For example, the heating assembly may configured such that, in a first mode, the device is ready for use a first period of time after the start of a session of use, and in a second mode, the device is ready for use a second period of time after the start of the session. The first period of time may be different from the second period of time.

In some examples, the heating assembly may be configured such that the aerosol provision device is ready for use within 30, 25 seconds, 20 seconds or 15 seconds of supplying power to a heating unit when operated in the first mode. The heating assembly may also be configured such that the aerosol provision device is ready for use in a shorter period of time when operating in the second mode-within 25 seconds, 20 seconds, 15 seconds, or 10 seconds of supplying power to a heating unit when operating in the second mode.

In a particular embodiment, the aerosol provision device may be configured such that the indicator indicates that the aerosol provision device is ready for use within 20 seconds of selection of a first (e.g. base) mode, and within 10 seconds of selection of a second (e.g. boost) mode.

Providing an aerosol provision device such as a tobacco heating product with a heating assembly that is operable in a plurality of modes (e.g. base mode and boost mode) gives more choice to the consumer, particularly where each mode is associated with a different maximum heater temperature. Moreover, such an aerosol provision device is capable of providing different aerosols having differing characteristics, because volatile components in the aerosol generating material will be volatilized at different rates and concentrations at different heater temperatures. This allows a user to select a particular mode based on a desired characteristic of the inhalable aerosol, such as degree of tobacco flavor, nicotine concentration, and aerosol temperature. For example, modes in which the aerosol provision device is ready for use more quickly (e.g. a second or “boost” mode) may provide a quicker first puff, or a greater nicotine content per puff, or a more concentrated flavor per puff. Conversely, modes in which the aerosol provision device is ready for use at a later point in the session of use (e.g. a first or base mode) may provide a longer overall session of use, lower nicotine content per puff, and more sustained delivery of flavor.

In embodiments wherein the aerosol provision device is ready for use more quickly in a second (e.g. boost) mode, and/or the first and/or second heating unit has a higher maximum operating temperature in the second mode, the second mode may be referred to as a “boost” mode. Various embodiments provide an aerosol provision device which is operable in a first “normal” or “base” mode and a second “boost” mode. The “boost” mode may provide a quicker first puff, or a greater nicotine content per puff, or a more concentrated flavor per puff.

The aerosol provision device may comprise a maximum of two aerosol generators. In other examples, the aerosol provision device may comprise more than two independently controllable aerosol generators, such as three, four or five independently controllable aerosol generators.

As discussed hereinabove, in some embodiments, at least one of the heating units provided in the heating assembly may comprise an induction heating unit. In these embodiments, the heating unit comprises an inductor (for example, one or more inductor coils), and the aerosol provision device may be arranged to pass a varying electrical current, such as an alternating current, through the inductor. The varying electric current in the inductor produces a varying magnetic field. When the inductor and the heating element are suitably relatively positioned so that the varying magnetic field produced by the inductor penetrates the heating element, one or more eddy currents are generated inside the heating element. The heating element has a resistance to the flow of electrical currents, so when such eddy currents are generated in the object, their flow against the electrical resistance of the object causes the object to be heated by Joule heating. Supplying a varying magnetic field to a susceptor may conveniently be referred to as supplying energy to a susceptor.

An aerosol generating system is disclosed comprising an aerosol provision device as described herein in combination with an aerosol generating article.

The aerosol provision device may comprise a heat not burn apparatus or a tobacco heating product (“THP”) for heating smokable material without burning or combusting the smokable material.

An aerosol provision device or aerosol generating device will now be described in more detail.

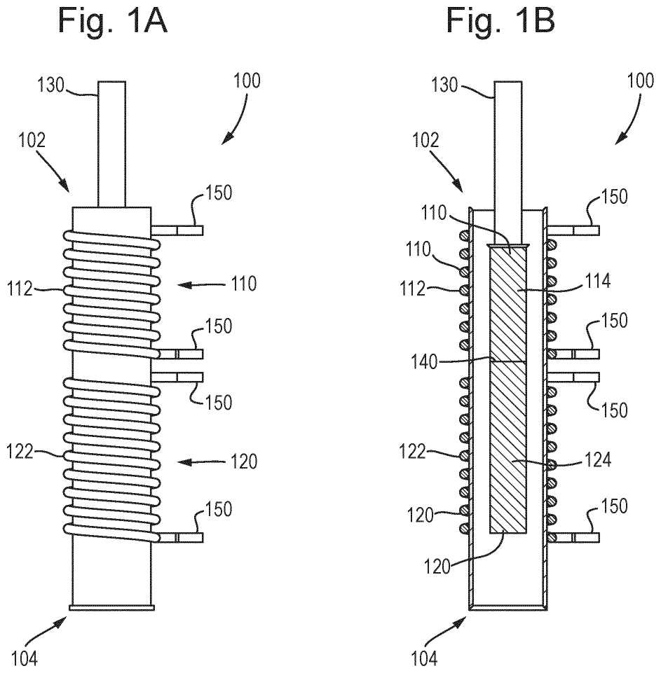

FIG. 1A shows an induction heating assembly 100 of an aerosol provision device which is given for illustrative purposes to illustrate various aspects of a heat not but aerosol provision device. FIG. 1B shows a cross section of the induction heating assembly 100 of the device. In alternative embodiments, the heating assembly may comprise a resistive heating assembly wherein the aerosol provision device comprises one or more electrically resistive heaters.

According to an embodiment the one or more electrically resistive heaters may comprise a winding of electrically resistive wire or a thin film. The winding of electrically resistive wire or thin film may be provided in a tubular arrangement which surrounds the aerosol generating article.

The heating assembly 100 has a first or proximal or mouth end 102, and a second or distal end 104. In use, the user will inhale the formed aerosol from the mouth end of the aerosol provision device. The mouth end may be an open end.

The heating assembly 100 comprises a first induction heating unit 110 and a second induction heating unit 120. The first induction heating unit 110 comprises a first inductor coil 112 and a first heating element 114. The second induction heating unit 120 comprises a second inductor coil 122 and a second heating element 124.

FIGS. 1A and 1B show an aerosol generating article 130 received within a susceptor 140 (see FIG. 1B). The susceptor 140 forms the first induction heating element 114 and the second induction heating element 124. The susceptor 140 may be formed from any material suitable for heating by induction. For example, the susceptor 140 may comprise metal. In some embodiments, the susceptor 140 may comprise non-ferrous metal such as copper, nickel, titanium, aluminium, tin, or zinc, and/or ferrous material such as iron, nickel or cobalt. Additionally or alternatively the susceptor 140 may comprise a semiconductor such as silicon carbide, carbon or graphite.

Each induction heating element present in the aerosol provision device may have any suitable shape. In the embodiment shown in FIG. 1B, the induction heating elements 114, 124 define a receptacle to surround an aerosol generating article and heat the aerosol generating article externally. In other embodiments (not shown), one or more induction heating elements may be substantially elongate, arranged to penetrate an aerosol generating article and heat the aerosol generating article internally.

As shown in FIG. 1B, the first induction heating element 114 and second induction heating element 124 may be provided together as a monolithic element 140. That is, in some embodiments, there is no physical distinction between the first 114 and second 124 heating elements. Rather, the differing characteristics between the first and second heating units 110, 120 are defined by separate inductor coils 112, 122 surrounding each induction heating element 114, 124, so that they may be controlled independently from each other. In other embodiments (not depicted), physically distinct inductive heating elements may be employed.

The first and second inductor coils 112, 122 may be made from an electrically conducting material. In this example, the first and second inductor coils 112, 122 are made from Litz wire/cable which is wound in a helical fashion to provide helical inductor coils 112, 122. Litz wire comprises a plurality of individual wires which are individually insulated and are twisted together to form a single wire. Litz wires are designed to reduce the skin effect losses in a conductor. In the example induction heating assembly 100, the first and second inductor coils 124, 126 are made from copper Litz wire which has a circular cross section. In other examples the Litz wire can have other shape cross sections, such as rectangular.

The first inductor coil 112 is configured to generate a first varying magnetic field for heating the first induction heating element 114, and the second inductor coil 122 is configured to generate a second varying magnetic field for heating a second section of the susceptor 124. The first inductor coil 112 and the first induction heating element 114 taken together form a first induction heating unit 110. Similarly, the second inductor coil 122 and the second induction heating element 124 taken together form a second induction heating unit 120.

In this example, the first inductor coil 112 is adjacent to the second inductor coil 122 in a direction along the longitudinal axis of the device heating assembly 100 (that is, the first and second inductor coils 112, 122 do not overlap). The susceptor arrangement 140 may comprise a single susceptor. Ends 150 of the first and second inductor coils 112, 122 can be connected to a controller such as a PCB (not shown). In embodiments, the controller comprises a PID controller (proportional integral derivative controller).

The varying magnetic field generates eddy currents within the first inductive heating element 114, thereby rapidly heating the first induction heating element 114 to a maximum operating temperature within a short period of time from supplying the alternative current to the coil 112, for example within 20, 15, 12, 10, 5, or 2 seconds. Arranging the first induction heating unit 110 which is configured to rapidly reach a maximum operating temperature closer to the mouth end 102 of the heating assembly 100 than the second induction heating unit 120 may mean that an acceptable aerosol is provided to a user as soon as possible after initiation of a session of use.

It will be appreciated that the first and second inductor coils 112, 122, in some examples, may have at least one characteristic different from each other. For example, the first inductor coil 112 may have at least one characteristic different from the second inductor coil 122. More specifically, in one example, the first inductor coil 112 may have a different value of inductance than the second inductor coil 122. In FIGS. 1A and 1B, the first and second inductor coils 112, 122 are of different lengths such that the first inductor coil 112 is wound over a smaller section of the susceptor 140 than the second inductor coil 122. Thus, the first inductor coil 112 may comprise a different number of turns than the second inductor coil 122 (assuming that the spacing between individual turns is substantially the same). In yet another example, the first inductor coil 112 may be made from a different material to the second inductor coil 122. In some examples, the first and second inductor coils 112, 122 may be substantially identical.

In this example, the first inductor coil 112 and the second inductor coil 122 are wound in the same direction. However, in another embodiment, the inductor coils 112, 122 may be wound in opposite directions. This can be useful when the inductor coils are active at different times. For example, initially, the first inductor coil 112 may be operating to heat the first induction heating element 114, and at a later time, the second inductor coil 122 may be operating to heat the second induction heating element 124. Winding the coils in opposite directions helps reduce the current induced in the inactive coil when used in conjunction with a particular type of control circuit. In one example, the first inductor coil 112 may be a right-hand helix and the second inductor coil 122 a left-hand helix. In another example, the first inductor coil 112 may be a left-hand helix and the second inductor coil 122 may be a right-hand helix.

The coils 112, 122 may have any suitable geometry. Without wishing to be bound by theory, configuring an induction heating element to be smaller (e.g. smaller pitch helix; fewer revolutions in the helix; shorter overall length of the helix), may increase the rate at which the induction heating element can reach a maximum operating temperature. In some embodiments, the first coil 112 may have a length of less than approximately 20 mm, less than 18 mm, less than 16 mm, or a length of approximately 14 mm, in the longitudinal direction of the heating assembly 100. The first coil 112 may have a length shorter than the second coil 124 in the longitudinal direction of the heating assembly 100. Such an arrangement may provide asymmetrical heating of the aerosol generating article along the length of the aerosol generating article.

The susceptor 140 of this example is hollow and therefore defines a receptacle within which aerosol generating material is received. For example, the article 130 can be inserted into the susceptor 140. In this example the susceptor 140 is tubular, with a circular cross section.

The induction heating elements 114 and 124 are arranged to surround the aerosol generating article 130 and heat the aerosol generating article 130 externally. The aerosol provision device is configured such that, when the aerosol generating article 130 is received within the susceptor 140, the outer surface of the article 130 abuts the inner surface of the susceptor 140. This ensures that the heating is most efficient. The article 130 of this example comprises aerosol generating material. The aerosol generating material is positioned within the susceptor 140. The article 130 may also comprise other components such as a filter, wrapping materials and/or a cooling structure.

The heating assembly 100 is not limited to two heating units. In some examples, the heating assembly 100 may comprise three, four, five, six, or more than six heating units. These heating units may each be controllable independent from the other heating units present in the heating assembly 100.

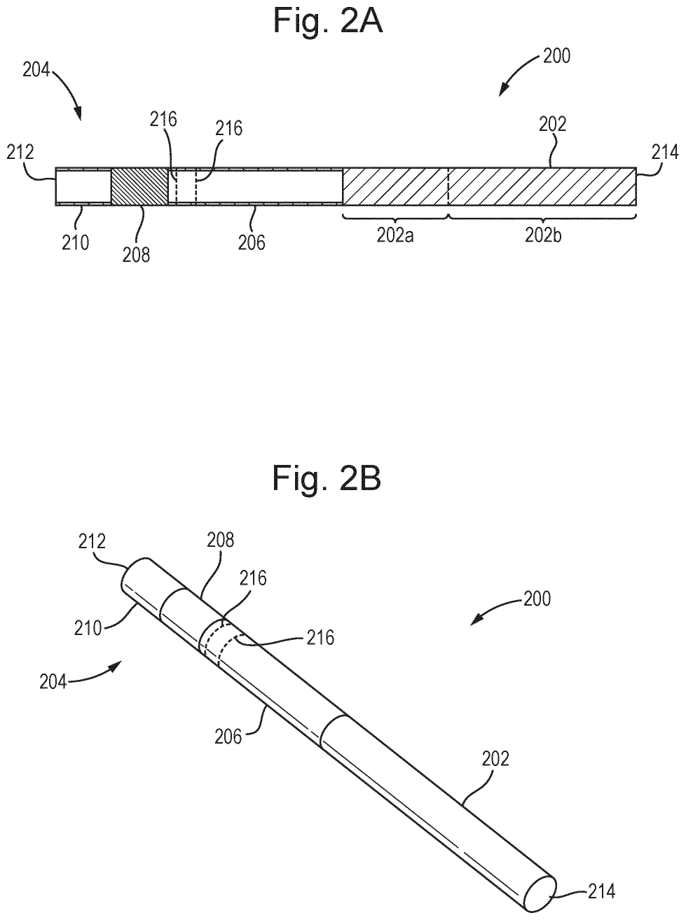

Referring to FIGS. 2A and 2B, there is shown a partially cut-away section view and a perspective view of an example of an aerosol generating article 200. The aerosol generating article 200 shown in FIGS. 2A and 2B corresponds to the aerosol generating article 130 shown in FIG. 1.

The aerosol generating article 200 may be any shape suitable for use with an aerosol provision device. The aerosol generating article 130 may be in the form of or provided as part of a cartridge or cassette or rod which can be inserted into the apparatus. In the embodiment shown in FIGS. 1A and 1B and 2, the aerosol generating article 130 is in the form of a substantially cylindrical rod that includes a body of smokable material 202 and a filter assembly 204 in the form of a rod. The filter assembly 204 includes three segments, a cooling segment 206, a filter segment 208 and a mouth end segment 210. The article 200 has a first end 212, also known as a mouth end or a proximal end and a second end 214, also known as a distal end. The body of aerosol generating material 202 is located towards the distal end 214 of the article 200. In one example, the cooling segment 206 is located adjacent the body of aerosol generating material 202 between the body of aerosol generating material 202 and the filter segment 208, such that the cooling segment 206 is in an abutting relationship with the aerosol generating material 202 and the filter segment 208. In other examples, there may be a separation between the body of aerosol generating material 202 and the cooling segment 206 and between the body of aerosol generating material 202 and the filter segment 208. The filter segment 208 is located in between the cooling segment 206 and the mouth end segment 210. The mouth end segment 210 is located towards the proximal end 212 of the article 200, adjacent the filter segment 208. In one example, the filter segment 208 is in an abutting relationship with the mouth end segment 210. In one embodiment, the total length of the filter assembly 204 is between 37 mm and 45 mm, and optionally the total length of the filter assembly 204 is 41 mm.

In use, portions 202a and 202b of the body of aerosol generating material 202 may correspond to the first induction heating element 114 and second induction heating element 124 of the portion 100 shown in FIG. 1B respectively.

The body of smokable material may have a plurality of portions 202a, 202b which correspond to the plurality of induction heating elements present in the aerosol provision device. For example, the aerosol generating article 200 may have a first portion 202a which corresponds to the first induction heating element 114 and a second portion 202b which corresponds to the second induction heating element 124. These portions 202a, 202b may exhibit temperature profiles which are different from each other during a session of use; the temperature profiles of the portions 202a, 202b may derive from the temperature profiles of the first induction heating element 114 and second induction heating element 124 respectively.

Where there is a plurality of portions 202a, 202b of a body of aerosol generating material 202, any number of the substrate portions 202a, 202b may have substantially the same composition. In a particular example, all of the portions 202a, 202b of the substrate have substantially the same composition. In one embodiment, body of aerosol generating material 202 is a unitary, continuous body and there is no physical separation between the first and second portions 202a, 202b, and the first and second portions have substantially the same composition.

In one embodiment, the body of aerosol generating material 202 comprises tobacco. However, in other respective embodiments, the body of smokable material 202 may consist of tobacco, may consist substantially entirely of tobacco, may comprise tobacco and aerosol generating material other than tobacco, may comprise aerosol generating material other than tobacco, or may be free of tobacco. The aerosol generating material may include an aerosol generating agent, such as glycerol.

In a particular embodiment, the aerosol generating material may comprise one or more tobacco components, filler components, binders and aerosol generating agents.

The filler component may be any suitable inorganic filler material. Suitable inorganic filler materials include, but are not limited to: calcium carbonate (i.e. chalk), perlite, vermiculite, diatomaceous earth, colloidal silica, magnesium oxide, magnesium sulphate, magnesium carbonate, and suitable inorganic sorbents, such as molecular sieves. Calcium carbonate is particularly suitable. In some cases, the filler comprises an organic material such as wood pulp, cellulose and cellulose derivatives.

The binder may be any suitable binder. In some embodiments, the binder comprises one or more of an alginate, celluloses or modified celluloses, polysaccharides, starches or modified starches, and natural gums.

Suitable binders include, but are not limited to: alginate salts comprising any suitable cation, such as sodium alginate, calcium alginate, and potassium alginate; celluloses or modified celluloses, such as hydroxypropyl cellulose and carboxymethylcellulose; starches or modified starches; polysaccharides such as pectin salts comprising any suitable cation, such as sodium, potassium, calcium or magnesium pectate; xanthan gum, guar gum, and any other suitable natural gums.

A binder may be included in the aerosol generating material in any suitable quantity and concentration.

The “aerosol generating agent” is an agent that promotes the generation of an aerosol. An aerosol generating agent may promote the generation of an aerosol by promoting an initial vaporization and/or the condensation of a gas to an inhalable solid and/or liquid aerosol. In some embodiments, an aerosol generating agent may improve the delivery of flavor from the aerosol generating article.

In general, any suitable aerosol generating agent or agents may be included in the aerosol generating material. Suitable aerosol generating agent include, but are not limited to: a polyol such as sorbitol, glycerol, and glycols like propylene glycol or triethylene glycol; a non-polyol such as monohydric alcohols, high boiling point hydrocarbons, acids such as lactic acid, glycerol derivatives, esters such as diacetin, triacetin, triethylene glycol diacetate, triethyl citrate or myristates including ethyl myristate and isopropyl myristate and aliphatic carboxylic acid esters such as methyl stearate, dimethyl dodecanedioate and dimethyl tetradecanedioate.

In a particular embodiment, the aerosol generating material comprises a tobacco component in an amount of from 60 to 90% by weight of the tobacco composition, a filler component in an amount of 0 to 20% by weight of the tobacco composition, and an aerosol generating agent in an amount of from 10 to 20% by weight of the tobacco composition. The tobacco component may comprise paper reconstituted tobacco in an amount of from 70 to 100% by weight of the tobacco component.

In one example, the body of aerosol generating material 202 is between 34 mm and 50 mm in length, optionally, the body of aerosol generating material 202 is between 38 mm and 46 mm in length, optionally still, the body of aerosol generating material 202 is 42 mm in length.

In one example, the total length of the article 200 is between 71 mm and 95 mm, optionally, total length of the article 200 is between 79 mm and 87 mm, optionally still, total length of the article 200 is 83 mm.

An axial end of the body of aerosol generating material 202 is visible at the distal end 214 of the article 200. However, in other embodiments, the distal end 214 of the article 200 may comprise an end member (not shown) covering the axial end of the body of aerosol generating material 202.

The body of aerosol generating material 202 is joined to the filter assembly 204 by annular tipping paper (not shown), which is located substantially around the circumference of the filter assembly 204 to surround the filter assembly 204 and extends partially along the length of the body of aerosol generating material 202. In one example, the tipping paper is made of 58GSM standard tipping base paper. In one example has a length of between 42 mm and 50 mm, and optionally, the tipping paper has a length of 46 mm.

In one example, the cooling segment 206 is an annular tube and is located around and defines an air gap within the cooling segment. The air gap provides a chamber for heated volatilized components generated from the body of aerosol generating material 202 to flow. The cooling segment 206 is hollow to provide a chamber for aerosol accumulation yet rigid enough to withstand axial compressive forces and bending moments that might arise during manufacture and whilst the article 200 is in use during insertion into the device 100. In one example, the thickness of the wall of the cooling segment 206 is approximately 0.29 mm.

The cooling segment 206 provides a physical displacement between the aerosol generating material 202 and the filter segment 208. The physical displacement provided by the cooling segment 206 will provide a thermal gradient across the length of the cooling segment 206. In one example the cooling segment 206 is configured to provide a temperature differential of at least 40° C. between a heated volatilized component entering a first end of the cooling segment 206 and a heated volatilized component exiting a second end of the cooling segment 206. In one example the cooling segment 206 is configured to provide a temperature differential of at least 60° C. between a heated volatilized component entering a first end of the cooling segment 206 and a heated volatilized component exiting a second end of the cooling segment 206. This temperature differential across the length of the cooling element 206 protects the temperature sensitive filter segment 208 from the high temperatures of the aerosol generating material 202 when it is heated by the heating assembly 100 of the device aerosol provision device. If the physical displacement was not provided between the filter segment 208 and the body of aerosol generating material 202 and the heating elements 114, 124 of the heating assembly 100, then the temperature sensitive filter segment may 208 become damaged in use, so it would not perform its required functions as effectively.

In one example the length of the cooling segment 206 is at least 15 mm. In one example, the length of the cooling segment 206 is between 20 mm and 30 mm, more particularly 23 mm to 27 mm, more particularly 25 mm to 27 mm and more particularly 25 mm.

The cooling segment 206 is made of paper, which means that it is comprised of a material that does not generate compounds of concern, for example, toxic compounds when in use adjacent to the heater assembly 100 of the aerosol provision device. In one example, the cooling segment 206 is manufactured from a spirally wound paper tube which provides a hollow internal chamber yet maintains mechanical rigidity. Spirally wound paper tubes are able to meet the tight dimensional accuracy requirements of high-speed manufacturing processes with respect to tube length, outer diameter, roundness and straightness.

In another example, the cooling segment 206 is a recess created from stiff plug wrap or tipping paper. The stiff plug wrap or tipping paper is manufactured to have a rigidity that is sufficient to withstand the axial compressive forces and bending moments that might arise during manufacture and whilst the article 200 is in use during insertion into the device 100.

For each of the examples of the cooling segment 206, the dimensional accuracy of the cooling segment is sufficient to meet the dimensional accuracy requirements of high-speed manufacturing process.

The filter segment 208 may be formed of any filter material sufficient to remove one or more volatilized compounds from heated volatilized components from the smokable material. In one example the filter segment 208 is made of a mono-acetate material, such as cellulose acetate. The filter segment 208 provides cooling and irritation-reduction from the heated volatilized components without depleting the quantity of the heated volatilized components to an unsatisfactory level for a user.

The density of the cellulose acetate tow material of the filter segment 208 controls the pressure drop across the filter segment 208, which in turn controls the draw resistance of the article 200. Therefore, the selection of the material of the filter segment 208 is important in controlling the resistance to draw of the article 200. In addition, the filter segment 208 performs a filtration function in the article 200.

In one example, the filter segment 208 is made of a 8Y15 grade of filter tow material, which provides a filtration effect on the heated volatilized material, whilst also reducing the size of condensed aerosol droplets which result from the heated volatilized material which consequentially reduces the irritation and throat impact of the heated volatilized material to satisfactory levels.

The presence of the filter segment 208 provides an insulating effect by providing further cooling to the heated volatilized components that exit the cooling segment 206. This further cooling effect reduces the contact temperature of the user's lips on the surface of the filter segment 208.

One or more flavors may be added to the filter segment 208 in the form of either direct injection of flavored liquids into the filter segment 208 or by embedding or arranging one or more flavored breakable capsules or other flavor carriers within the cellulose acetate tow of the filter segment 208.

In one example, the filter segment 208 is between 6 mm to 10 mm in length, optionally 8 mm.

The mouth end segment 210 is an annular tube and is located around and defines an air gap within the mouth end segment 210. The air gap provides a chamber for heated volatilized components that flow from the filter segment 208. The mouth end segment 210 is hollow to provide a chamber for aerosol accumulation yet rigid enough to withstand axial compressive forces and bending moments that might arise during manufacture and whilst the article is in use during insertion into the device 100. In one example, the thickness of the wall of the mouth end segment 210 is approximately 0.2 9 mm.

In one example, the length of the mouth end segment 210 is between 6 mm to 10 mm and optionally 8 mm. In one example, the thickness of the mouth end segment is 0.29 mm.

The mouth end segment 210 may be manufactured from a spirally wound paper tube which provides a hollow internal chamber yet maintains critical mechanical rigidity. Spirally wound paper tubes are able to meet the tight dimensional accuracy requirements of high-speed manufacturing processes with respect to tube length, outer diameter, roundness and straightness.

The mouth end segment 210 provides the function of preventing any liquid condensate that accumulates at the exit of the filter segment 208 from coming into direct contact with a user.

It should be appreciated that, in one example, the mouth end segment 210 and the cooling segment 206 may be formed of a single tube and the filter segment 208 is located within that tube separating the mouth end segment 210 and the cooling segment 206.

A ventilation region 216 is provided in the article 200 to enable air to flow into the interior of the article 200 from the exterior of the article 200. In one example the ventilation region 216 takes the form of one or more ventilation holes 216 formed through the outer layer of the article 200. The ventilation holes may be located in the cooling segment 206 to aid with the cooling of the article 200. In one example, the ventilation region 216 comprises one or more rows of holes, and optionally, each row of holes is arranged circumferentially around the article 200 in a cross-section that is substantially perpendicular to a longitudinal axis of the article 200.

In one example, there are between one to four rows of ventilation holes to provide ventilation for the article 200. Each row of ventilation holes may have between 12 to 36 ventilation holes 216. The ventilation holes 216 may, for example, be between 100 to 500 μm in diameter. In one example, an axial separation between rows of ventilation holes 216 is between 0.25 mm and 0.75 mm, optionally, an axial separation between rows of ventilation holes 216 is 0.5 mm.

In one example, the ventilation holes 216 are of uniform size. In another example, the ventilation holes 216 vary in size. The ventilation holes can be made using any suitable technique, for example, one or more of the following techniques: laser technology, mechanical perforation of the cooling segment 206 or pre-perforation of the cooling segment 206 before it is formed into the article 200. The ventilation holes 216 are positioned so as to provide effective cooling to the article 200.

In one example, the rows of ventilation holes 216 are located at least 11 mm from the proximal end 212 of the article, optionally the ventilation holes are located between 17 mm and 20 mm from the proximal end 212 of the article 200. The location of the ventilation holes 216 is positioned such that user does not block the ventilation holes 216 when the article 200 is in use.

Providing the rows of ventilation holes between 17 mm and 20 mm from the proximal end 212 of the article 200 enables the ventilation holes 216 to be located outside of the device 100, when the article 200 is fully inserted in the device 100, as can be seen in FIG. 1. By locating the ventilation holes outside of the apparatus, non-heated air is able to enter the article 200 through the ventilation holes from outside the device 100 to aid with the cooling of the article 200.

The length of the cooling segment 206 is such that the cooling segment 206 will be partially inserted into the device 100, when the article 200 is fully inserted into the device 100. The length of the cooling segment 206 provides a first function of providing a physical gap between the heater arrangement of the device 100 and the heat sensitive filter arrangement 208, and a second function of enabling the ventilation holes 216 to be located in the cooling segment, whilst also being located outside of the device 100, when the article 200 is fully inserted into the device 100. As can be seen from FIG. 1, the majority of the cooling element 206 is located within the device 100. However, there is a portion of the cooling element 206 that extends out of the device 100. It is in this portion of the cooling element 206 that extends out of the device 100 in which the ventilation holes 216 are located.

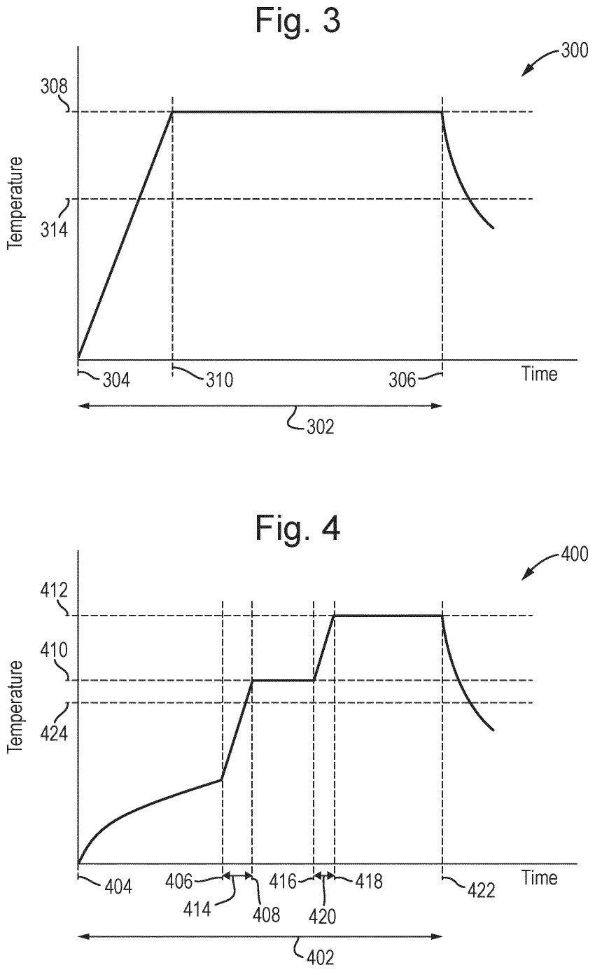

FIG. 3 depicts a temperature profile 300 of a first heating element in an aerosol provision device, such as the first inductive heating element 114 shown in FIG. 1B, during an exemplary session of use 302. The temperature profile 300 suitably refers to the temperature profile of the first inductive heating element 114 in any mode of operation of the heating assembly. The temperature profile 300 of the first heating element 114 is measured by a suitable temperature sensor disposed at the first heating element 114. Suitable temperature sensors include thermocouples, thermopiles or resistance temperature detectors (RTDs, also referred to as resistance thermometers). In a particular embodiment, the device comprises at least one RTD. In an embodiment, the device comprises thermocouples arranged on each heating element 114, 124 present in the aerosol provision device. The temperature data measured by the or each temperature sensor may be communicated to a controller. Further, it may communicated to the controller when a heating element 114, 124 has reached a prescribed temperature, such that the controller may change the supply of power to elements within the aerosol provision device accordingly. Optionally, the controller comprises a PID (proportional integral derivative) controller, which uses a control loop feedback mechanism to control the temperature of the heating elements based on data supplied from one or more temperature sensors disposed in the device. In an embodiment, the controller comprises a PID controller configured to control the temperature of each heating element based on temperature data supplied from thermocouples disposed at each of the heating elements.

The session of use 302 begins when the device is activated 304 and the controller controls the device to supply energy to at least the first induction heating unit 110. The device may be activated by a user by, for example, actuating a push button, or inhaling from the device. Actuating means for use with an aerosol provision device are known to the person skilled in the art. In the context of a heater assembly comprising induction heating means, the session of use begins when the controller instructs a varying electrical current to be supplied to an inductor (such as first and second coils 112, 122) and thus a varying magnetic field to be supplied to the induction heating element, generating a rise in temperature of the induction heating element. As mentioned hereinabove, this may conveniently be referred to as “supplying energy to the induction heating unit”.

The end 306 of the session of use session of use 302 occurs when the controller instructs elements in the device to stop supplying energy to all heating units present in the aerosol provision device. In the context of a heater assembly comprising induction heating units, the session of use ends when varying electrical current ceases to be supplied to any of the induction heating elements provided in the heating assembly, such that any varying magnetic field ceases to be supplied to the induction heating elements.

At the beginning of the smoking session 302 the temperature of the first heating element rapidly increases until it reaches the maximum operating temperature 308. The time taken 310 to reach the maximum operating temperature 308 may be referred to as the “ramp-up” period, and has a duration of less than 20 seconds according to various embodiments.

The temperature of the first heating element may optionally drop from the maximum operating temperature 308 to a lower temperature 314 later in the session of use 312. If the temperature drops from the maximum operating temperature 308 later in the session of use 302, it is preferred that the temperature to which the first heating element drops 314 is an operating temperature. The operating temperature to which the first heating element drops 314 may suitable be referred to as the “second operating temperature” 314. Optionally, the temperature of the first heating element does not drop below the lowest operating temperature of the first heating element until the end 306 of the session of use 302. The first heating element optionally remains at or above the second operating temperature 314 until the end 306 of the session of use 302.

In embodiments wherein the heating assembly is operable in a plurality of modes (e.g. base mode and boost mode), the temperature of the first heating element may drop from the maximum operating temperature 308 to a second operating temperature 314 in at least one of the modes. Optionally, the temperature of the first heating element drops from the maximum operating temperature 308 to a second operating temperature 314 in all of the operable modes. For the avoidance of doubt, the maximum operating temperature 308 and second operating temperature 314 of the first heating element may differ from mode to mode.

In some examples, the second operating temperature 314 is from 180 to 240° C. Where the heating assembly is operable in a plurality of modes, the second operating temperature 314 in at least one mode of operation may be from 180 to 240° C. Optionally, the second operating temperature 314 in all modes of operating may be from 180 to 240° C. Optionally still, the second operating temperature 314 is at least 220° C. In some examples, the first heating element or heating units remains at or above the second operating temperature 314 until the end of the session of use in all modes of operation. Without wishing to be bound by theory, configuring the heating assembly such that the first heating element does not drop below 220° C. until the end of the session of use 220 may at least partially prevent condensation from occurring in the first portion of the aerosol generating article during the session of use, and/or also reduce resistance to draw provided by the first portion of the aerosol generating article.

In these embodiments, the first heating element may remain at or substantially close to the highest operating temperature for up to least 25%, 50%, or 75% of the session. For example, the first heating element may remain at its maximum operating temperature for a first duration of the session of use, then drop to and remain at the second operating temperature for a second duration of the session of use, the first duration being at least 25%, 50%, or 75% of the session. The first duration may be longer or shorter than the second duration. Optionally, in at least one mode of operation, the first duration is longer than the second duration. In this example, the ratio of the first duration to the second duration may be from 1.1:1 to 7:1, from 1.5:1 to 5:1, from 2:1 to 3:1, or approximately 2.5:1.

In a particular embodiment, the device is operable in a plurality of modes, and the ratios listed above apply to the first mode of operation. In the second mode of operation, the first duration may be longer or shorter than the second duration. Optionally, the second duration is longer than the first duration. Thus, one embodiment is a device which is configured such that in a first mode of operation, the first duration is longer than the second duration, but in the second mode of operation, the second duration is longer than the first duration. In one embodiment, in the second mode of operation, the ratio of the second duration to the first duration may be from 1.1:1 to 5:1, from 1.2 to 2:1 or from 1.3:1 to 1.4:1. In another embodiment, in the second mode of operation, the ratio of the second duration to the first duration may be from 2:1 to 12:1, from 2.5:1 to 11:1. In particular, the ratio may be from 3:1 to 4:1; alternatively, the ratio may be from 8:1 to 10:1. This embodiment may be particularly suitable for reducing the amount of condensate formed in the device during a session of use.

It has been determined that operating the first heating element at its maximum operating temperature for a greater proportion of the session of use may help in reducing the amount of condensate which collects in the device during use. This effect may be particularly noticeable in so-called “boost” modes of operation where the heating unit operates at a higher maximum operating temperature during a shorter session of use.

The maximum operating temperature 308 may be from approximately 200° C. to 300° C., or 210° C. to 290° C., or 220° C. to 280° C., or, 230° C. to 270° C., or 240° C. to 260° C.

FIG. 4 depicts a temperature profile 400 of a second heating element when present in an aerosol provision device, such as the second inductive heating element 124 shown in FIG. 1B, during an exemplary smoking session 402. Smoking session 402 corresponds to smoking session 302 shown in FIG. 3. The temperature profile 400 suitably refers to the temperature profile of the second inductive heating element 124 in any mode of operation of the heating assembly.

The session of use 402 begins when the device is activated 404 and energy is supplied to at least the first induction heating unit. In this example, the controller is configured not to supply energy to the second induction heating unit at the start of the session of use 402. Nevertheless, the temperature at the second induction heating element will likely rise somewhat due to thermal “bleed”-conduction, convection and/or radiation of thermal energy from the first heating element 114 to the second heating element 124.

At a first programmed time point 406 after the beginning of the session of use, the controller instructs energy to be supplied to the second heating unit 120 and the temperature of the second heating element 124 rises rapidly until the time point 408 at which a predetermined first operating temperature 410 is reached, then the controller controls the second heating unit 120 such that the second heating element 124 remains at substantially this temperature for a further period of time. The predetermined first operating temperature 410 may be lower than the maximum operating temperature 412 of the second heating element 124. In other embodiments (not shown), the first predetermined operating temperature is the maximum operating temperature; that is, the second heating element 124 is directly heated to its maximum operating temperature upon activation of the second heating unit 120.

In some embodiments, the predetermined first operating temperature 410 is from 150° C. to 200° C. The predetermined first operating temperature 410 may be greater than 150° C., 160° C., 170° C., 180° C., or 190° C. The predetermined first operating temperature 410 may be less than 200° C., 190° C., 180° C., 170° C., or 160° C. Optionally, the predetermined first operating temperature 410 is from 150° C. to 170° C. A lower first operating temperature 410 may help to reduce the amount of undesirable condensate which collects in the device.

In embodiments wherein the heating assembly is operable in a plurality of modes, the heating assembly may be configured such that the second heating element 124 rises to a first operating temperature 410, maintains the first operating temperature 410, then subsequently rises to the maximum operating temperature 412, in at least one mode. Optionally, the heating assembly is configured such that the second heating element 124 rises to a first operating temperature 410, maintains the first operating temperature 410, then subsequently rises to the maximum operating temperature 412 in all operable modes.

The first programmed time point 406 at which power is first supplied to the second heating unit 120 may be at least approximately 10 seconds, 20 seconds, 30 seconds, 40 seconds, 50 seconds, or 60 seconds after activation of the device 404. For embodiments wherein the heating assembly is operable in a plurality of modes, the first programmed time point 406 is at least approximately 10 seconds, 20 seconds, 30 seconds, 40 seconds, 50 seconds, 60 seconds, 70 seconds, or 80 seconds after activation of the device 404 in at least one mode. Optionally, the first programmed time point 406 is at least approximately 10 seconds, 20 seconds, 30 seconds, 40 seconds, 50 seconds, 60 seconds, 70 seconds, or 80 seconds after activation of the device 404 in all operable modes. The first programmed time point 406 may be the same in each mode, or it may differ between modes. Optionally, the first programmed time point 406 differs between the modes. In particular, the first programmed time point 406 may be at a later point in the session of use in the first mode than in the second mode.

In some embodiments, the heating assembly 100 may be configured such that the second induction unit 120 rises to the predetermined operating temperature 410 within 10 seconds, or 5 seconds, 4 seconds, 3 seconds or 2 seconds of the programmed time point 406 for increasing the temperature of the second induction heating element 124 to the first predetermined operating temperature 410. Put another way, the period 414 between the two time points 406, 408 may have a duration of 10 seconds or less, 5 seconds or less, 4 seconds or less, 3 seconds or less, or 2 seconds or less. Optionally, the period 414 has a duration of 2 seconds or less.

The second heating element 124 may be kept at the predetermined first operating temperature 410 for a predetermined period of time until a second programmed time point 416 at which the controller controls the second heating unit such that the second heating element 124 rises to its maximum operating temperature 412. At this second programmed time point 416 the temperature of the second heating element 124 rises rapidly until the time point 418 at which the maximum operating temperature 412 is reached. Then, the controller controls the second heating unit such that the second heating element 124 remains at substantially this temperature for a further period of time.

The second programmed time point 416 may be at least approximately 10 seconds, 20 seconds, 30 seconds, 40 seconds, 50 seconds, or 60 seconds after activation of the device 404.

In some embodiments, the heating assembly 100 may be configured such that the second induction element 124 rises from the first predetermined operating temperature 410 to the maximum operating temperature 412 within 10 seconds, or 5 seconds, 4 seconds, 3 seconds or 2 seconds of the programmed time point 416 for increasing the temperature of the second induction heating element 124 to the maximum operating temperature 412. Put another way, the period 420 between the two time points 416, 418 may have a duration of 10 seconds or less, 5 seconds or less, 4 seconds or less, 3 seconds or less, or 2 seconds or less. Optionally, the period 420 has a duration of 2 seconds or less.

The temperature of the second heating element in the period from timepoint 416 to timepoint 418 may rise at a rate of at least 50° C. per second, or 100° C. per second, or 150° C. per second.

In some embodiments the heating assembly 100 may be configured such that the second induction heating element 124 reaches the maximum operating temperature 412 after at least approximately 30 seconds, 40 seconds, 50 seconds, 60 seconds, 80 seconds, 100 seconds, or 120 seconds from activation of the device 404. Optionally, the heating assembly 100 is configured such that the second induction heating element 124 reaches the maximum operating temperature 412 after at least approximately 120 seconds after activation of the device 404.

In some embodiments, the heating assembly 100 may be configured such that the second induction heating element 124 reaches the maximum operating temperature 412 after at least approximately 10 seconds, 20 seconds, 30 seconds, 40 seconds, 50 seconds, 60 seconds, 80 seconds, 100 seconds, or 120 seconds from the first induction heating element 122 reaching its maximum operating temperature 308. Optionally the heating assembly 100 is configured such that the second induction heating element 124 reaches its maximum operating temperature 412 after at least approximately 120 seconds from the first induction heating element 122 reaching its maximum operating temperature 308. Put another way, with reference to FIGS. 3 and 4, time point 418 may be at least 120 seconds later than time point 310 during the smoking session 302, 402.

The second heating element 124 may be kept at its maximum operating temperature 412 for a predetermined period of time until the end of the smoking session 422, at which point the controller controls the heating assembly such that energy ceases to be supplied to all heating elements present in the aerosol provision device. Optionally, after the temperature of the second heating element 124 has reached an operating temperature (roughly around the first predetermined time point 406), the temperature of the second heating element 124 does not drop below the lowest operating temperature 424 of the second heating element 124 until the end of the smoking session 402.

In embodiments wherein the first heating element 122 drops from a maximum operating temperature 308 to a lower temperature later in the smoking session, the second heating element 124 may reach its maximum operating temperature 412 before the temperature drop of the first heating element 122, after the temperature drop of the first heating element 122, or concurrent with the temperature drop of the first heating element 122. In an embodiment, the second heating element 124 reaches its maximum operating temperature 412 before the first heating element 122 drops from its maximum operating temperature 308 to a lower temperature.

In some embodiments, the maximum operating temperature 308 of the first heating element 122 is substantially the same as that of the second heating element 124. In other embodiments the maximum operating temperatures 308, 412 of the first and second heating elements 122, 124 may differ. For example, the maximum operating temperature 308 of the first heating element 122 may be greater than that of the second heating element 124, or the maximum operating temperature 412 of the second heating element 124 may be greater than that of the first heating element 122. In one embodiment, the maximum operating temperature 308 of the first heating element 122 is greater than the maximum operating temperature 412 of the second heating element 124. In another embodiment, the maximum operating temperature 308 of the first heating element 122 is substantially the same as that of the second heating element 124.

For periods during which a heating element remains at a substantially constant temperature, there may be minor fluctuations in the temperature around the target temperature defined by the controller. In some embodiments, the fluctuation is less than approximately ±10° C., or ±5° C., or ±4° C., or ±3° C., or ±2° C., or ±1° C. Optionally the fluctuation is less than approximately ±3° C. for at least the first heating element, at least the second heating element, or both the first heating element and second element.

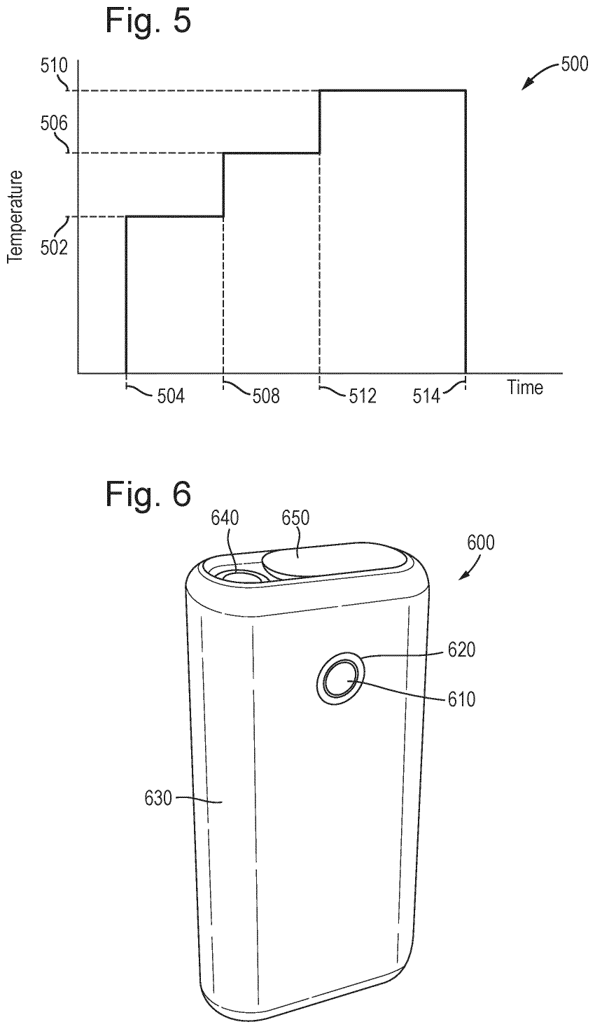

FIGS. 3 and 4 discussed hereinabove reflect the measured or observed temperature profile of heating unit(s) present in the device 100. FIG. 5 reflects a programmed heating profile of any heating unit(s) present in the device 100. Any programmed heating profile of any heating unit present in the heating assembly of the present device may be depicted by the general programmed heating profile as shown in FIG. 5.

A programmed heating profile 500 includes a first temperature, temperature A 502. Temperature A 502 is the first temperature which the heating unit is programmed to reach during a given session of use, at timepoint A 504. Timepoint A 504 may conveniently be defined in terms of the number of seconds elapsed from the start of a session of use, i.e. from the point at which power is first supplied to at least one heating unit present in the heating assembly.

Optionally, a programmed heating profile 500 may include a second temperature, temperature B 506. Temperature B 506 is a temperature different to temperature A 502. In some embodiments, the device is programmed to reach temperature B 506 during a given session of use at timepoint B 508. Timepoint B 508 occurs temporally after timepoint A 504.

From timepoint A 504 to timepoint B 508, the device is programmed to have substantially the same temperature, temperature A 502. However, in some embodiments, there may be variation about temperature A 502 in this period. For example, the heating unit may have a temperature within 10° C. of temperature A 502 during this period, optionally within 5° C. of temperature A 502 during this period. Such profiles are still considered to correspond to the profile shown generally in FIG. 5. In other embodiments, there is substantially no variation from temperature A 502 during this period.

Even though FIG. 5 depicts temperature B 506 being higher than temperature A 502, the programmed heating profiles of the present disclosure are not so limited: temperature B 506 may be higher or lower than temperature A 502 for any given heating profile.

Optionally, a programmed heating profile 500 includes a second temperature, Temperature B 506.

Optionally, a programmed heating profile 500 may include a third temperature, temperature C 510. Temperature C 510 is a temperature different to temperature B. In some embodiments, the device is programmed to reach to temperature C 510 during a given session of use at timepoint C 512. Timepoint C 512 occurs temporally after timepoint B 508 and thus timepoint A 502.

Temperature C 510 may or may not be the same temperature as temperature A 502.

Even though FIG. 5 depicts temperature C 510 being higher than temperature B 506 and temperature A 502, the programmed temperature profiles of the present disclosure are not so limited: temperature C 510 may be higher or lower than temperature A 502 for any given heating profile; temperature C 510 may be higher or lower than temperature B 506 for any given heating profile.

The programmed heating profile 500 includes a final timepoint 514, the point at which energy stops being supplied to the heating unit for the rest of the session of use. It may be that the final timepoint 514 is concurrent with the end of the session of use.

Surprisingly, it has been found that the temperatures 502, 506, 510 and timepoints 504, 508, 512, 514 of the programmed heating profile of the heating unit(s) may be modulated to reduce the accumulation of condensation in a device 100. In particular, configuring the device such that timepoint B 508 occurs after 50% of the session of use has elapsed, optionally after 75% of the session of use has elapsed, may reduce the amount of condensate which collects in the device in use.

In embodiments wherein the heating assembly comprises at least two heating units, the heating assembly may be configured such that the first and second heating units have substantially the same maximum operating temperature. The inventors have identified that this configuration may also reduce the accumulation of condensation in the device.

FIG. 6 shows an example of an aerosol provision device 600 according an embodiment. The device comprises a user interface 610 and an indicator 620. In this example, the user interface 610 is a push button. The indicator 620 comprises a visual indicator. The indicator 620 may also comprise a haptic indicator (not shown). The haptic indicator of the indicator 620 is disposed apart from the visual indicator in the device 600.

The indicator 620 is arranged to surround the user interface 610. It has been found that arranging the indicator 620 to surround the user interface 610 may mean that a user finds the device simpler to operate.

The user interface 610 may have a substantially circular shape in a first plane. The user interface 610 may extend in a dimension perpendicular to the first plane and may have a convex or concave shape. The user interface 610 may form a concave shape on the surface of the device. Providing the user interface 610 with a concave shape may allow for simpler and more accurate operation of the device with the fingertip of a user. The indicator 620 may have a substantially circular outline. The indicator 620 may be provided as an annulus so that the user interface 610 may be provided in the centre of the indicator 620.

The device 600 comprises a housing 630. The housing 630 may be provided with a receptacle 640 for receiving an aerosol generating article in use. The receptacle 640 comprises a heating assembly (not shown) for heating, but not burning, the aerosol-generating article disposed therein. The device 600 may optionally further comprise a movable cover 650 for covering the opening of the receptacle 640 when the device is not in use. The movable cover 650 may comprise a sliding cover. A user may interact with the user interface 610 to activate the device. The device is configured such that the device is activated by depression of the push button by a user.

The device may be configured so that one of two modes may be set prior to commencing a session of use. One mode of operation which may be set is a “normal” mode and the second mode of operation which may be set is “boost” mode. The user may interact with the user interface 610 to select a mode of operation prior to commencing a session of use. The device is configured such that the modes of operation are selectable by depressing the push button for differing periods. Once a mode of operation is selected, power is supplied to at least one heating unit or aerosol in the generator heating assembly.

The device 600 may be configured such that, once a mode of operation has been selected by a user, the indicator 620 indicates the selected mode to the user. The selected mode may be indicated by activation of light sources in the visual indicator component of the indicator 620 in a pre-determined manner. The selected mode may also indicated by activation of the haptic indicator component of the indicator 620 in a pre-determined manner.

At least one component of the indicator 620 may continue to indicate the selected mode to the user until the device is ready for use. The visual indicator portion of the indicator 620 may continue to indicate the selected mode from the point at which the mode is selected until the device is ready for use, at which point the indicator may indicate that the device is ready for use.

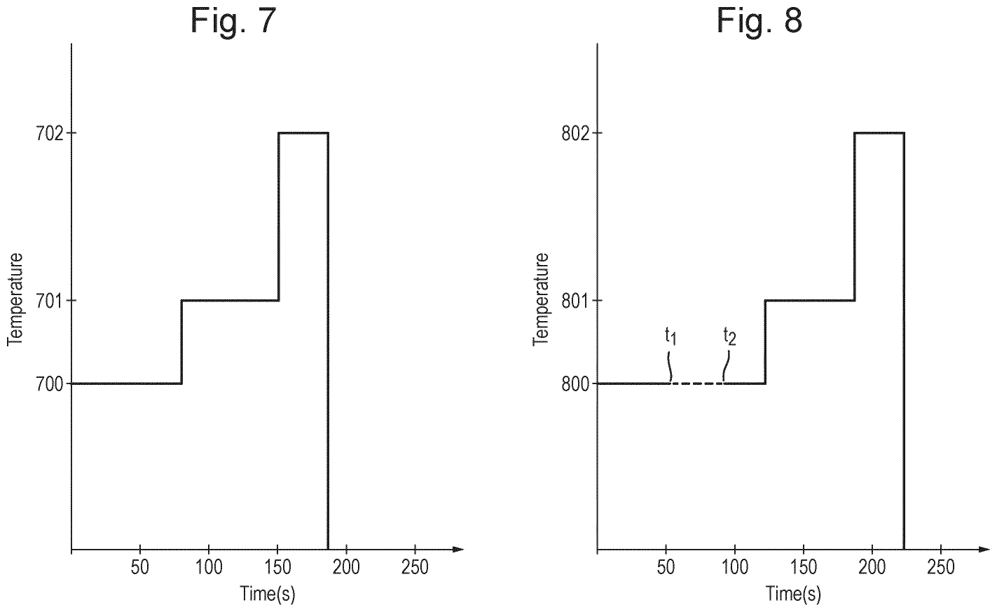

FIG. 7 shows a heating profile which may be set for one or more aerosol generators according to an embodiment. A session of use may be deemed to commence at time 0 s and for the time period 0-80 s the one or more aerosol generators are set a target operating temperature 700. After 80 s, the heating profile increases to temperature 701 until time 150 s so that the one or more aerosol generators are set a target operating temperature 701 during the time period 80-150 s. After 150 s, the heating profile increases to temperature 702 until time 180 s so that the one or more aerosol generators are set a target operating temperature 702 during time period 150-180 s. The session of use finishes at time 180 s when energy or power to the one or more aerosol generators is turned OFF.

It will be understood that a heating profile may be selected by a user prior to commencing a session of use. For example, a user may select between a normal mode of operation and a boost mode of operation.

However, in addition to selecting a heating profile prior to commencing a session of use according to various embodiments a user may also interact with a user interface after a session of use has commenced in order to vary the heating profile which is set for the one or more aerosol generators for the remainder of the session of use.

In particular, a user may interact with the user interface at a time t1 after a session of use has commenced in order to cause the controller to enter one or more further modes of operation.

According to an embodiment, a user may interact with the user interface at a time t1 after a session of use has commenced in order to pause or alter further operation of the one or more aerosol generators.

FIG. 8 shows a heating profile according to an embodiment wherein at a time t1 after a session of use has commenced a user has pressed the user interface in order to cause the aerosol provision device to enter a pause mode of operation. In the particular example shown in FIG. 8 the operation of the aerosol provision device is paused for 40 s between time 50-90 s.

In the example shown in FIG. 8 the heating profile is such that when the operation of the aerosol provision device is paused between time 50-90 s the controller continues to set the same operating temperature 800 for the one or more aerosol generators.

However, other embodiments are contemplated wherein if the controller is caused to pause or alter further operation of the one or more aerosol generators then the controller may be further arranged to turn OFF or reduce energy or power supplied to the one or more aerosol generators.

If the controller is caused to pause or alter further operation of the one or more aerosol generators then the controller may be further arranged to prevent aerosol from being generated from the aerosol generating material.

The user interface may be further arranged so as to enable a user to further interact with the user interface at a subsequent time t2 in order to cause the controller either: (i) to restart operation of the one or more aerosol generators; and/or (ii) to cause the one or more aerosol generators to exit from a power saving mode of operation.

The controller may be further arranged to turn OFF energy or power supplied to the one or more aerosol generators after a predetermined period of time subsequent to time t1 if a user has not further interacted with the user interface subsequent to time t1. The predetermined period of time may be <10 s, 10-20 s, 20-30 s, 30-40 s, 40-50 s, 50-60 s, 60-70 s, 70-80 s, 80-90 s, 90-100 s, 100-110 s, 110-120 s, 120-130 s, 130-140 s, 140-150 s, 150-160 s, 160-170 s, 170-180 s or >180 s.

With reference to FIG. 8, a user has then pressed the user interface a second time at a time t2 (90 s) in order to cause the aerosol provision device to move out of pause mode whereupon the heating profile which was set for the one or more aerosol generators resumes. Due to the introduction of a 40 s delay the heating profile now finishes at a later time 220 s i.e. 40 s after the end of the heating profile shown in FIG. 7.

According to an embodiment if the controller is caused to pause or alter further operation of the one or more aerosol generators then the controller may be further arranged to reduce energy or power supplied to the one or more aerosol generators so that the operational temperature of the one or more aerosol generators drops to a temperature T1, wherein T1≤200° C. Optionally, T1 is selected from the group consisting of: (i)<20° C.; (ii) 20-40° C.; (iii) 40-60° C.; (iv) 60-80° C.; (v) 80-100° C.; (vi) 100-120° C.; (vii) 120-140° C.; (viii) 140-160° C.; (ix) 160-180° C.; and (x) 180-200° C.

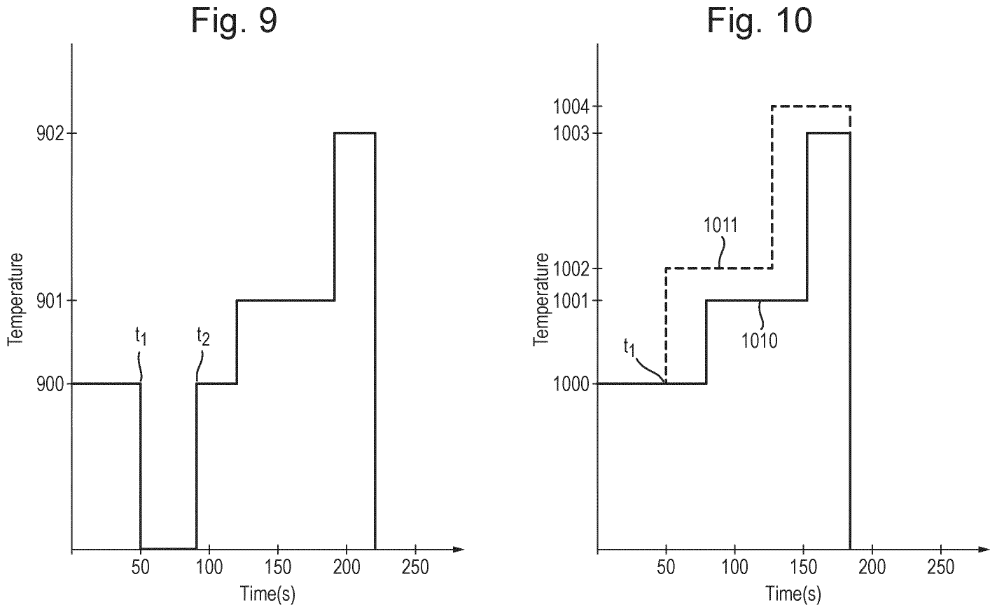

FIG. 9 shows a heating profile according to an embodiment wherein at a time t1 (50 s) after a session of use has commenced a user has pressed the user interface in order to cause the aerosol provision device to enter a power saving mode of operation.

In the particular embodiment illustrated in FIG. 9 the aerosol provision device is placed into a power saving mode at time 50 s which results in energy or power to the one or more aerosol generators being turned OFF in order to conserve power.

At a subsequent time t2 (90 s) the user has pressed the user interface a second time in order to cause the aerosol provision device to move out of a power saving mode of operation whereupon the heating profile which is set for the one or more aerosol generators resumes. Due to the period of 40 s during which the device entered into a power saving mode of operation the heating profile now finishes at time 220 s i.e. 40 s after the end of the heating profile shown in FIG. 7.

According to another embodiment, a user may interact with the user interface at a time t1 after a session of use has commenced in order to change or vary a heating profile which is set for the one or more aerosol generators for the remainder of the session of use from time t1 onwards.

FIG. 10 illustrates an embodiment wherein at a time t1 (50 s) a user interacts with the user interface in order to change the heating profile which is set for the one or more aerosol generators for the remainder of the session of use. Prior to pressing the user interface at time t1 a heating profile 1010 as shown in FIG. 10 was set for the one or more aerosol generators. However, as a result of pressing the user interface at time t1 a different heating profile 1011 may now be set for the remainder of the session of use.

According to another embodiment, a user may interact with the user interface at a time t1 after a session of use has commenced in order to change or vary the duration of a heating profile which is set for the one or more aerosol generators for the remainder of the session of use from time t1 onwards. For example, the duration of the heating profile may be increased or decreased.

In the example shown in FIG. 10 the heating profile 1010 is increased following a user interacting with the user interface at time t1. According to other embodiments, the length of a session of use may also be shortened when the temperature of the heating profile is increased.

Conversely, the heating profile 1010 may be decreased following a user interacting with the user interface at time t1. It is contemplated, for example, that if the heating profile 1020 is decreased then the length of a session of use may also be lengthened.

Yet further embodiments are contemplated wherein following a user interacting with the user interface at time t1 a new heating profile which is substantially different in terms of the profile may be set for the one or more heating units for the remainder of the session of use.

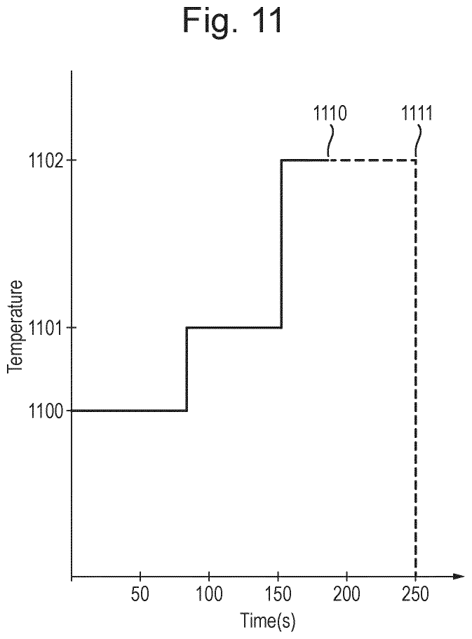

FIG. 11 illustrates an embodiment wherein a user interacts with the user interface during a session of use in order to vary the duration of a heating profile which set for the one or more aerosol generators. According to the particular embodiment shown in FIG. 11 if a user interacts with the user interface at any time after the session of use has commenced then the duration of the heating profile may be extended so that instead of the heating profile terminating 1110 at time 180 s the heating profile is now extended until a later time 1111 which in the particular example shown in FIG. 11 is at time 250 s.

According to an embodiment prior to time t1 (when a user interacts with the user interface) the controller is arranged to set a first heating profile for the one or more aerosol generators having a first average operating temperature T1 throughout an intended session of use and wherein following interaction by a user with the user interface from time t1 onwards the controller is arranged to set a second different heating profile for the one or more aerosol generators so that the one or more aerosol generators have a second average operating temperature T2 throughout the session of use, wherein either T1>T2 or T2>T1.

According to an embodiment following interaction by a user with the user interface at time t1 the controller is arranged to increase or progressively increase the operational temperature of the one or more aerosol generators.

According to an alternative embodiment following interaction by a user with the user interface at time t1 the controller is arranged to decrease or progressively decrease the operational temperature of the one or more aerosol generators.

Following interaction by a user with the user interface at time t1 the controller may be arranged to increase the duration of a heating profile which is set for the one or more aerosol generators for the remainder of the session of use from time t1 onwards.

Alternatively, following interaction by a user with the user interface at time t1 the controller may be arranged to decrease the duration of a heating profile which is set for the one or more aerosol generators for the remainder of the session of use from time t1 onwards.

More generally, following interaction by a user with the user interface at time t1 the controller may be arranged to set a different predetermined heating profile for the one or more aerosol generators.

The one or more aerosol generators may comprise one or more induction heating units.

The one or more aerosol generators may comprise one or more resistive or non-induction heating units.

The one or more aerosol generators may comprise one or more external heating units.

The one or more aerosol generators comprise one or more internal heating units.

An external heating unit will be understood as comprising a heating unit which surrounds an aerosol generating article and directs heat into the outer portion of the aerosol generating article which then heats the remaining portion of the aerosol generating article. The external heating unit(s) may comprise an induction heating unit(s) and/or a resistive heating unit(s).

By way of contrast, an internal heating unit comprises a heating unit which enters into or which is provided within the main body of the aerosol generating article. For example, an internal heating unit may comprise a blade provided in the base of a heating chamber of the aerosol provision device. The aerosol generating article when inserted into the aerosol provision device will be pushed down onto the blade with the result that the blade extends into the distal end of the aerosol generating article. According to various embodiments the internal heating unit(s) may comprise resistive heating units wherein an electrical current is passed through the heating unit in order to heat the heating unit. However, other embodiments are contemplated wherein the internal heating unit(s) may comprise induction heating unit(s). An induction heating unit may comprise an induction coil for generating a time varying magnetic field and a susceptor. The induction coil and the susceptor are suitably relatively positioned so that the varying magnetic field produced by the inductor penetrates the susceptor and one or more eddy currents are generated inside the susceptor. The susceptor has a resistance to the flow of electrical current, so when such eddy currents are generated in the susceptor, their flow against the electrical resistance of the susceptor causes the susceptor to be heated by Joule heating. For example, a susceptor may be provided in the base of a heating chamber of the aerosol provision device such that the aerosol generating article is pushed onto the susceptor when the aerosol generating article is inserted into the aerosol provision device. The susceptor may then be heated by an induction coil which may be spaced at a distance from the internal susceptor.

If the controller is caused to change or vary a heating profile which is set for the one or more aerosol generators for the remainder of the session of use from time t1 onwards then the controller may be further arranged to increase or decrease the temperature of the one or more aerosol generators.

The one or more aerosol generators may comprise a first heating unit and a second heating unit.

According to an embodiment either: (i) the first heating unit comprises an induction heating unit and the second heating unit comprises an induction heating unit; (ii) the first heating unit comprises an induction heating unit and the second heating unit comprises a resistive or non-induction heating unit; (iii) the first heating unit comprises a resistive or non-induction heating unit and the second heating unit comprises an induction heating unit; or (iv) the first heating unit comprises a resistive or non-induction heating unit and the second heating unit comprises a resistive or non-induction heating unit.

According to an embodiment either: (i) the first heating unit comprises an external heating unit and the second heating unit comprises an external heating unit; (ii) the first heating unit comprises an external heating unit and the second heating unit comprises an internal heating unit; (iii) the first heating unit comprises an internal heating unit and the second heating unit comprises an internal heating unit; or (iv) the first heating unit comprises an internal heating unit and the second heating unit comprises an external heating unit.

If the controller is caused to change or vary a heating profile which is set for the one or more aerosol generators for the remainder of the session of use from time t1 onwards then the controller may be arranged to increase or reduce the temperature of the first heating unit.

If the controller is caused to change or vary a heating profile which is set for the one or more aerosol generators for the remainder of the session of use from time t1 onwards then the controller may be arranged to increase or reduce the temperature of the second heating unit.

A session of use may be determined to begin when power or energy is first supplied to the one or more aerosol generators after an aerosol generating article has been inserted into the aerosol provision device.

A session of use may be determined to begin when power or energy is first supplied to the one or more aerosol generators in order to raise the temperature of the one or more aerosol generators to an operating temperature Tmin such that a user can take a first puff of aerosol generated from the aerosol generating material. Optionally, Tmin is in the range: (i) 200-210° C.; (ii) 210-220° C.; (iii) 220-230° C.; (iv) 230-240° C.; (v) 240-250° C.; (vi) 250-260° C.; (vii) 260-270° C.; (viii) 270-280° C.; (ix) 280-290° C.; and (x) 290-300° C.

A session of use may be determined to end when power or energy is no longer supplied to the one or more aerosol generators.

A session of use may be determined to end when the aerosol generating material is substantially spent or wherein a user is unable to take further puffs of aerosol generated from the aerosol generating material.

A session of use may be determined to relate to a period of time during which a user is enabled to take multiple puffs of aerosol generated from aerosol generating material without replacement or replenishment of the aerosol generating material.

The aerosol provision device may additionally or alternatively comprise a first device arranged to detect the frequency at which a user is taking puffs of aerosol or if no puff has been taken in a predetermined period of time, wherein if the frequency is above or below a pre-determined level (or if no puff has been detected during the predetermined period of time) then the controller is further arranged to prompt a user to interact with the user interface. The first device may comprise a microphone.

The aerosol provision device may additionally or alternatively comprise a second device arranged to detect the frequency at which a user is taking puffs of aerosol or if no puff has been taken in a predetermined period of time, wherein if the frequency is below a pre-determined level (or if no puff has been detected during the period of time) then the controller is further arranged either to pause the operation of the one or more aerosol generators or to turn OFF energy or power supplied to the one or more aerosol generators.

According to various embodiments the aerosol provision device may be arranged to detect when a new or fresh puff is taken after a period of detecting no puffs being taken which has resulted in the device entering a power saving mode. Upon the detection of a new or fresh puff being taken the aerosol provision device may restart operation.

Further embodiments are contemplated wherein the aerosol provision device may be arranged to detect that a user is taking puffs at a frequency above a threshold (which may be user set or predetermined) and whereupon the aerosol provision device may then change the mode of operation. For example, the aerosol provision device may change the mode of operation so that the aerosol provision device operates in mode of operation having an increased temperature profile or otherwise changed temperature or heating profile such as a boost mode of operation.

Additionally or alternatively, the aerosol provision device may be arranged to detect that a user is taking puffs at a frequency above a threshold (which may be user set or predetermined) and whereupon the aerosol provision device may then prompt a user to interact with the user interface.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

The invention claimed is:

1. An aerosol provision device for generating aerosol from aerosol generating material, wherein the aerosol provision device comprises:
one or more aerosol generators arranged to cause aerosol to be generated from the aerosol generating material;
a controller for controlling the one or more aerosol generators; and
a user interface arranged so as to enable a user to interact with the user interface at a time t1 after a session of use has commenced in order to cause the controller either: (i) to pause or alter further operation of the one or more aerosol generators; and/or (ii) to cause the one or more aerosol generators to enter into a power saving mode of operation; and/or (iii) to change or vary a heating profile which is set for the one or more aerosol generators for the remainder of the session of use from time t1 onwards; and/or (iv) to change or vary the duration of a heating profile which is set for the one or more aerosol generators for the remainder of the session of use from time t1 onwards.

2. An aerosol provision device as claimed in claim 1, wherein if the controller is caused to pause or alter further operation of the one or more aerosol generators then the controller is further arranged to reduce energy or power supplied to the one or more aerosol generators so that the operational temperature of the one or more aerosol generators drops to a temperature T1, wherein T1≤200° C.

3. (canceled)

4. An aerosol provision device as claimed in claim 1, wherein if the controller is caused to pause or alter further operation of the one or more aerosol generators then the controller is further arranged to turn OFF energy or power supplied to the one or more aerosol generators.

5. An aerosol provision device as claimed in claim 1, wherein if the controller is caused to pause or alter further operation of the one or more aerosol generators then the controller is further arranged to prevent aerosol from being generated from the aerosol generating material.

6. An aerosol provision device as claimed in claim 1, wherein the user interface is further arranged so as to enable a user to further interact with the user interface at a subsequent time t2 in order to cause the controller either: (i) to restart operation of the one or more aerosol generators; and/or (ii) to cause the one or more aerosol generators to exit from a power saving mode of operation.

7. An aerosol provision device as claimed in claim 1, wherein the controller is further arranged to turn OFF energy or power supplied to the one or more aerosol generators after a predetermined period of time subsequent to time t1 if a user has not further interacted with the user interface subsequent to time t1.

8. An aerosol provision device as claimed in claim 1, wherein prior to time t1 the controller is arranged to set a first heating profile for the one or more aerosol generators having a first average operating temperature T1 throughout an intended session of use and wherein following interaction by a user with the user interface from time t1 onwards the controller is arranged to set a second different heating profile for the one or more aerosol generators so that the one or more aerosol generators have a second average operating temperature T2 throughout the session of use, wherein either T1>T2 or T2>T1.

9. An aerosol provision device as claimed in claim 1, wherein following interaction by a user with the user interface at time t1 the controller is arranged to increase or progressively increase the operational temperature of the one or more aerosol generators.

10. An aerosol provision device as claimed in claim 1, wherein following interaction by a user with the user interface at time t1 the controller is arranged to decrease or progressively decrease the operational temperature of the one or more aerosol generators.

11. An aerosol provision device as claimed in claim 1, wherein following interaction by a user with the user interface at time t1 the controller is arranged to increase the duration of a heating profile which is set for the one or more aerosol generators for the remainder of the session of use from time t1 onwards.

12. An aerosol provision device as claimed in claim 1, wherein following interaction by a user with the user interface at time t1 the controller is arranged to decrease the duration of a heating profile which is set for the one or more aerosol generators for the remainder of the session of use from time t1 onwards.

13. An aerosol provision device as claimed in claim 1, wherein following interaction by a user with the user interface at time t1 the controller is arranged to set a different predetermined heating profile for the one or more aerosol generators.

14. (canceled)

15. (canceled)

16. (canceled)

17. (canceled)

18. An aerosol provision device as claimed in claim 1, wherein if the controller is caused to change or vary a heating profile which is set for the one or more aerosol generators for the remainder of the session of use from time t1 onwards then the controller is further arranged to increase or decrease the temperature of the one or more aerosol generators.

19. An aerosol provision device as claimed in claim 1, wherein the one or more aerosol generators comprise a first heating unit and a second heating unit.

20. An aerosol provision device as claimed in claim 19, wherein either: (i) the first heating unit comprises an induction heating unit and the second heating unit comprises an induction heating unit; (ii) the first heating unit comprises an induction heating unit and the second heating unit comprises a resistive or non-induction heating unit; (iii) the first heating unit comprises a resistive or non-induction heating unit and the second heating unit comprises an induction heating unit; or (iv) the first heating unit comprises a resistive or non-induction heating unit and the second heating unit comprises a resistive or non-induction heating unit.

21. An aerosol provision device as claimed in claim 19, wherein either: (i) the first heating unit comprises an external heating unit and the second heating unit comprises an external heating unit; (ii) the first heating unit comprises an external heating unit and the second heating unit comprises an internal heating unit; (iii) the first heating unit comprises an internal heating unit and the second heating unit comprises an internal heating unit; or (iv) the first heating unit comprises an internal heating unit and the second heating unit comprises an external heating unit.

22. (canceled)

23. (canceled)

24. (canceled)

25. (canceled)

26. (canceled)

27. (canceled)

28. (canceled)

29. (canceled)

30. (canceled)

31. (canceled)

32. An aerosol provision device as claimed in claim 1, further comprising a second device arranged to detect the frequency at which a user is taking puffs of aerosol, wherein if the frequency is below a pre-determined level then the controller is further arranged either to pause the operation of the one or more aerosol generators or to turn OFF energy or power supplied to the one or more aerosol generators.

33. An aerosol generating system comprising:
an aerosol provision device as claimed in claim 1; and
an aerosol generating article comprising aerosol generating material.

34. An aerosol generating system as claimed in claim 33, wherein the aerosol generating article is inserted, in use, into the aerosol provision device.

35. A method of generating aerosol comprising:
providing an aerosol provision device comprising one or more aerosol generators arranged to cause aerosol to be generated from the aerosol generating material and wherein the aerosol provision device further comprises a user interface;
inserting an aerosol generating article into the aerosol provision device; and
in response to a user interacting with the user interface at a time t1 after a session of use has commenced, either: (i) pausing or altering further operation of the one or more aerosol generators; and/or (ii) causing the one or more aerosol generators to enter into a power saving mode of operation; and/or (iii) changing or varying a heating profile which is set for the one or more aerosol generators for the remainder of the session of use from time t1 onwards; and/or (iv) changing or varying the duration of a heating profile which is set for the one or more aerosol generators for the remainder of the session of use from time t1 onwards.
